(19) United States
(12) Patent Application Publication
(10) Pub. No.: US 2025/0292021 A1
(43) Pub. Date: Sep. 18, 2025

(54) CLASSIFICATION USING A GRAMMAR-CONSTRAINED GENERATIVE LANGUAGE MODEL

(71) Applicant: Shopify Inc., Ottawa (CA)

(72) Inventor: Kshetrajna Raghavan, Fremont, CA (US)

(21) Appl. No.: 18/744,792

(22) Filed: Jun. 17, 2024

Related U.S. Application Data
(60) Provisional application No. 63/566,636, filed on Mar. 18, 2024.
(60) Provisional application No. 63/656,347, filed on Jun. 5, 2024.

(51) Int. Cl. G06F 40/284; G06F 40/211; G06V 10/764; G06V 10/82

(52) U.S. Cl. CPC G06F 40/284; G06F 40/211; G06V 10/764; G06V 10/82

(57) ABSTRACT

Typical classifiers must be trained on a large input sample to accurately classify inputs. In addition, if a new classification category needs to be added to a taxonomy after the classifier has already been trained to classify within the taxonomy, the classifier must be recreated and retrained to classify within the updated taxonomy. To address at least these technical problems with classifiers, a generative language model may be used to perform classification. A generative language model is a machine learning model that generates language, typically in the form of a textual response to a data input. A generative language model may utilize a large neural network to determine probabilities for a next token of a sequence of text conditional on previous or historical tokens in the sequence of text. An LLM is an example of a generative language model.

### RELATED APPLICATION

This application claims the benefit of and priority from United States provisional patent application no. U.S. 63/566,636, filed Mar. 18, 2024, and United States provisional patent application no. U.S. 63/656,347, filed Jun. 5, 2024, the entire contents of which are incorporated herein by reference.

### FIELD

The present application relates to generative models that utilize machine learning, such as large language models (LLMs), and more particularly to employing a grammar-constrained generative language model as a classifier.

### BACKGROUND

Classifiers are a type of algorithm used for classifying or categorizing a data input. Typical classifiers may be implemented using, for example, neural networks, K-nearest neighbours and support vector machines.

### SUMMARY

A typical classifier is “trained” on a training data set, which may include inputs and labels. The trained classifier may be configured to identify the likelihood that an input belongs to one or more classifications or categories (e.g. within a taxonomy). The classifications may correspond with the labels used in the training stage.

For example, a typical classifier may be trained on images of clothing items and, for each image, one or more labels indicating the type of clothing item, such as a shoe, pants and a shirt. Once trained, the trained classifier may receive an image and may output an indication that the image depicts one of a shoe, pants or a shirt.

In one implementation, given an input image depicting a shoe, the classifier may output a high likelihood that the image is a shoe, as well as probabilities indicating whether the input image is a pant or a shirt, respectively.

In alternative implementations, the typical classifier may be configured to output only a single classification of the input, such as indicating that the input image depicts a shoe. The single classification may be accompanied with a confidence value, indicating the classifier's confidence in the classification.

However, it will be appreciated that typical classifiers must be trained on a large input sample to accurately classify inputs. For example, if a classifier is trained to classify elements in an image with 128 pixels, a large sample size may be required for the classifier to accurately classify based on this limited information. A typical classifier is not provided with additional context to help classify the image beyond the 128 pixels.

In addition, if a new classification category needs to be added to a taxonomy after the classifier has already been trained to classify within the taxonomy, the classifier must be recreated and retrained to classify within the updated taxonomy. Similarly, a separate classifier may be needed to classify each separate taxonomy, i.e. a first classifier may be needed to classify clothing items and a second classifier may be needed to classify brands of cars. Typical classifiers may thus pose scaling challenges.

To address the technical problems with classifiers explained above, a generative language model may be used to perform classification. A generative language model is a machine learning model that generates language, typically in the form of a textual response to a data input. A generative language model may utilize a large neural network to determine probabilities for a next token of a sequence of text conditional on previous or historical tokens in the sequence of text. An LLM is an example of a generative language model.

In some implementations, to address the technical problems with classifiers explained above, a prompt may be received that instructs a generative language model to classify an input to the generative language model. A grammar may be obtained responsive to the prompt. The grammar may define valid sequences of symbols corresponding to a plurality of categories, wherein the input may be classified into one or more of the plurality of categories. The generative language model may generate a sequence of symbols identifying the one or more categories. The sequence may be based on the input and conform to the grammar.

One example is as follows. An input to a generative language model may be an image. The image may depict a shoe. A prompt may include an instruction that instructs the generative language model to classify the image. A grammar may be obtained responsive to the prompt, such as based on the instruction. The grammar may define valid sequences of symbols corresponding to a plurality of categories. The plurality of categories may be associated with “clothing items”, and may include “shoe”, “pants” and “shirt”. The image may be classified into one or more of the plurality of categories. The generative language model may generate a sequence of symbols identifying the one or more categories. The sequence may be based on the image and conform to the grammar.

In one aspect, there is provide a computer-implemented method. The method may include receiving a prompt that instructs a generative language model to classify an input to the generative language model. The method may also include obtaining a grammar responsive to the prompt, the grammar defining valid sequences of symbols corresponding to a plurality of categories. The input may be classified into one or more of the plurality of categories. The method may also include generating, using the generative language model, a sequence of symbols identifying the one or more categories, the sequence based on the input and conforming to the grammar.

In some implementations, the method may further include outputting an indication of the one or more categories into which the input has been classified based on the sequence of symbols.

In some implementations, the symbols may include tokens, and generating the sequence of symbols may include: generating a plurality of values using the generative language model, each of the values indicative of a probability of a respective token being a next token of the sequence; applying a mask to the plurality of values, the mask operating on each value that corresponds to a token not compliant with the grammar to reduce or zero the probability of the token being the next token; and determining the next token based on the plurality of values after the mask is applied.

In some implementations, the sequence of symbols, when mapped to text, may provide a written indication of the one or more categories.

In some implementations, the prompt may further include an instruction, and obtaining the grammar responsive to the prompt may further include obtaining the grammar based on the instruction.

In some implementations, the instruction includes information associated with the plurality of categories; and obtaining the grammar based on the instruction may further include: encoding the information associated with the plurality of categories within the grammar, wherein the encoding is in a format for parsing.

In some implementations, the grammar may further include a label representative of the plurality of categories to which the grammar relates; and obtaining the grammar based on the instruction may further include: determining that the instruction is associated with the label; and selecting the grammar from a set of one or more grammars.

In some implementations, a memory may include information associated with the plurality of categories; and obtaining the grammar based on the instruction may further include: retrieving the information associated with the plurality of categories from the memory; and encoding the information associated with the plurality of categories within the grammar, wherein the encoding is in a format for parsing.

In some implementations, the method may further include receiving an update to the plurality of categories, the update including at least one of an addition of a new category to the plurality of categories, a removal of a category from the plurality categories, or a modification of a category within the plurality of categories; and modifying the valid sequences of symbols in the grammar based on the update to the plurality of categories.

In some implementations, the generative language model is a large language model (LLM).

In some implementations, the grammar may further constrain the valid sequences of symbols to a syntax of a programming language; and outputting an indication of the one or more categories into which the input has been classified based on the sequence of symbols may include outputting code of the programming language.

In another aspect, there is provided a system. The system may include a memory to store a grammar. The system may further include at least one processor to: receive a prompt that instructs a generative language model to classify an input to the generative language model; obtain the grammar responsive to the prompt, the grammar defining valid sequences of symbols corresponding to a plurality of categories, wherein the input can be classified into one or more of the plurality of categories; and generate, using the generative language model, a sequence of symbols identifying the one or more categories, the sequence based on the input and conforming to the grammar.

In some implementations, the at least one processor is to output an indication of the one or more categories into which the input has been classified based on the sequence of symbols.

In some implementations, the symbols may include tokens, and generating the sequence of symbols may include: generating a plurality of values using the generative language model, each of the values indicative of a probability of a respective token being a next token of the sequence; applying a mask to the plurality of values, the mask operating on each value that corresponds to a token not compliant with the grammar to reduce or zero the probability of the token being the next token; and determining the next token based on the plurality of values after the mask is applied.

In some implementations, the sequence of symbols, when mapped to text, provides a written indication of the one or more categories.

In some implementations, the prompt may further include an instruction, and obtaining the grammar responsive to the prompt may further include obtaining the grammar based on the instruction.

In some implementations, the instruction may include information associated with the plurality of categories; and obtaining the grammar based on the instruction may further include: encoding the information associated with the plurality of categories within the grammar, wherein the encoding is in a format for parsing.

In some implementations, the grammar may further include a label representative of the plurality of categories to which the grammar relates; and obtaining the grammar based on the instruction may further include: determining that the instruction is associated with the label; and selecting the grammar from a set of one or more grammars.

In some implementations, obtaining the grammar based on the instruction may further include: retrieving information associated with the plurality of categories; and encoding the information associated with the plurality of categories within the grammar, wherein the encoding is in a format for parsing.

In some implementations, the at least one processor is further to: receive an update to the plurality of categories, the update including at least one of an addition of a new category to the plurality of categories, a removal of a category from the plurality categories, or a modification of a category within the plurality of categories; and modify the valid sequences of symbols in the grammar based on the update to the plurality of categories.

In some implementations, the generative language model is a large language model (LLM).

In some implementations, the grammar may further constrain the valid sequences of symbols to a syntax of a programming language; and wherein outputting an indication of the one or more categories into which the input has been classified based on the sequence of symbols may include outputting code of the programming language.

In another aspect, there is provided one or more computer readable media having stored thereon computer-executable instructions that, when executed by at least one computer, may cause the at least one computer to perform a method including: receiving a prompt that instructs a generative language model to classify an input to the generative language model; obtaining a grammar responsive to the prompt, the grammar defining valid sequences of symbols corresponding to a plurality of categories, where the input may be classified into one or more of the plurality of categories; and generating, using the generative language model, a sequence of symbols identifying the one or more categories, the sequence based on the input and conforming to the grammar.

In another aspect, there is a provided a system including: at least one processor; and at least one memory storing processor-executable instructions that, when executed, cause the at least one processor to perform any of the methods disclosed herein.

In another aspect, there is provided one or more computer readable media having stored thereon computer-executable instructions that, when executed by at least one computer, cause the at least one computer to perform any of the methods disclosed herein. The computer readable media may be non-transitory.

### BRIEF DESCRIPTION OF THE DRAWINGS

Embodiments will be described, by way of example only, with reference to the accompanying figures wherein:

FIG. 1A is a simplified block diagram of an example simplified convolutional neural network;

FIG. 1B is a simplified block diagram of an example transformer neural network; and

FIG. 2 is a block diagram of an example computing system;

FIG. 3 is a block diagram of an example system for classifying an input;

FIG. 4 illustrates an example multi-step processes for classifying an input using the system of FIG. 3;

FIGS. 5-6 illustrate additional examples of the multi-step process of FIG. 4, according to some embodiments;

FIG. 7 illustrates an example of a generative language model generating a sequence of tokens for use by the system of FIG. 3, according to some embodiments;

FIGS. 8-9 illustrate examples of applying a mask to the generative language model of FIG. 7;

FIG. 10 is a block diagram of another system for describing classifying an input using a generative language model, according to some embodiments;

FIG. 11 is a block diagram of a variation of the system of FIG. 10;

FIG. 12 illustrates a method performed by a computing system;

FIGS. 13-17 illustrate examples corresponding to steps of the method of FIG. 12;

FIG. 18 illustrates another method performed by a computing system;

FIG. 19 illustrates a grammar, according to some embodiments; and

FIG. 20 is a block diagram of an example communication system for a user device to communicate with the system of FIG. 3.

### DETAILED DESCRIPTION

For illustrative purposes, specific embodiments will now be explained in greater detail below in conjunction with the figures.

To assist in understanding the present disclosure, some concepts relevant to neural networks and machine learning (ML) are first discussed.

Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which need not be discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), and multilayer perceptrons (MLPs), among others.

DNNs are often used as ML-based models for modeling complex behaviors (e.g., human language, image recognition, object classification, etc.) in order to improve accuracy of outputs (e.g., more accurate predictions) such as, for example, as compared with models with fewer layers. In the present disclosure, the term “ML-based model” or more simply “ML model” may be understood to refer to a DNN. Training a ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model. For example, to train a ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. In another example, to train a ML model that is intended to classify images, the training dataset may be a collection of images. Training data may be annotated with ground truth labels (e.g. each data entry in the training dataset may be paired with a label), or may be unlabeled.

Training a ML model generally involves inputting into an ML model (e.g. an untrained ML model) training data to be processed by the ML model, processing the training data using the ML model, collecting the output generated by the ML model (e.g. based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or may be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training a ML model. Backpropagation is used to adjust (also referred to as update) the value of the parameters in the ML model, with the goal of optimizing the objective function. For example, a defined loss function is calculated by forward propagation of an input to obtain an output of the ML model and comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively, so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of a ML model typically involves further training the ML model on a number of data samples (which may be smaller in number/cardinality than those used to train the model initially) that closely target the specific task. For example, a ML model for generating natural language that has been trained generically on publicly-available text corpuses may be, e.g., fine-tuned by further training using the complete works of Shakespeare as training data samples (e.g., where the intended use of the ML model is generating a scene of a play or other textual content in the style of Shakespeare).

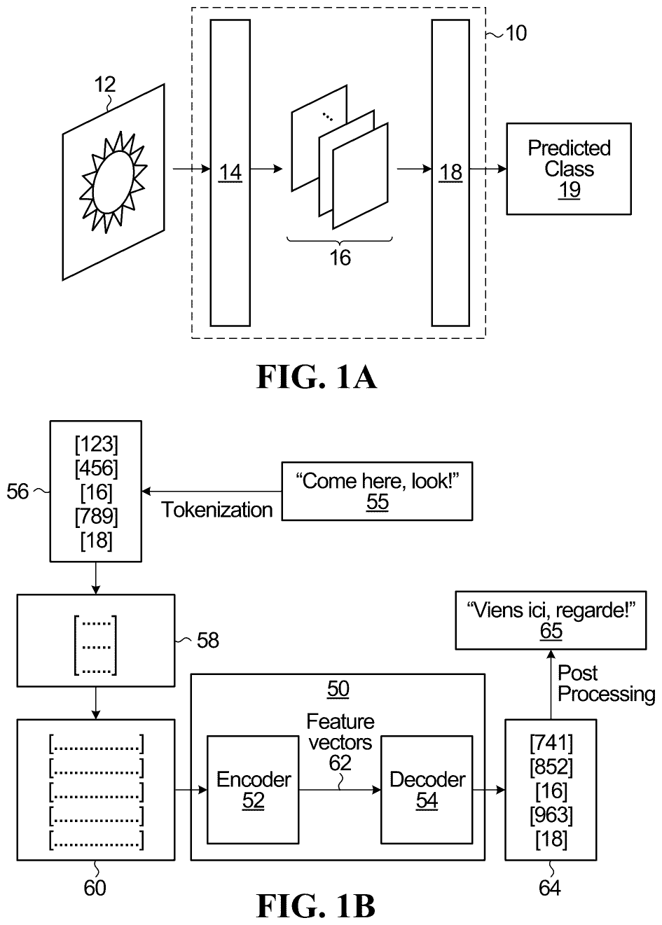

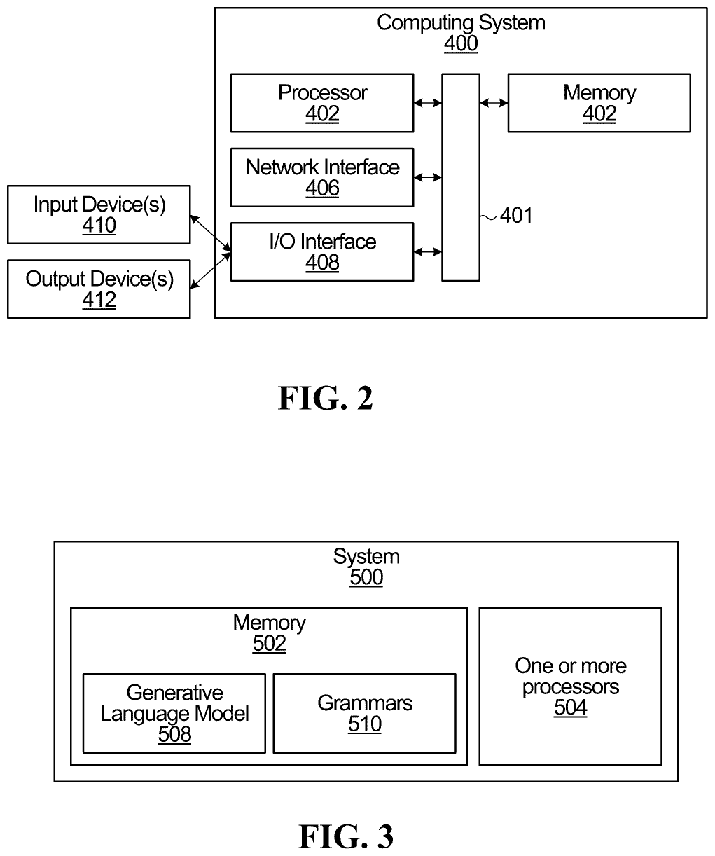

FIG. 1A is a simplified diagram of an example CNN 10, which is an example of a DNN that is commonly used for image processing tasks such as image classification, image analysis, object segmentation, etc. An input to the CNN 10 may be a 2D RGB image 12.

The CNN 10 includes a plurality of layers that process the image 12 in order to generate an output, such as a predicted classification or predicted label for the image 12. For simplicity, only a few layers of the CNN 10 are illustrated including at least one convolutional layer 14. The convolutional layer 14 performs convolution processing, which may involve computing a dot product between the input to the convolutional layer 14 and a convolution kernel. A convolutional kernel is typically a 2D matrix of learned parameters that is applied to the input in order to extract image features. Different convolutional kernels may be applied to extract different image information, such as shape information, color information, etc.

The output of the convolution layer 14 is a set of feature maps 16 (sometimes referred to as activation maps). Each feature map 16 generally has smaller width and height than the image 12. The set of feature maps 16 encode image features that may be processed by subsequent layers of the CNN 10, depending on the design and intended task for the CNN 10. In this example, a fully connected layer 18 processes the set of feature maps 16 in order to perform a classification of the image, based on the features encoded in the set of feature maps 16. The fully connected layer 18 contains learned parameters that, when applied to the set of feature maps 16, outputs a set of probabilities representing the likelihood that the image 12 belongs to each of a defined set of possible classes. The class having the highest probability may then be outputted as the predicted classification for the image 12.

In general, a CNN may have different numbers and different types of layers, such as multiple convolution layers, max-pooling layers and/or a fully connected layer, among others. The parameters of the CNN may be learned through training, using data having ground truth labels specific to the desired task (e.g., class labels if the CNN is being trained for a classification task, pixel masks if the CNN is being trained for a segmentation task, text annotations if the CNN is being trained for a captioning task, etc.), as discussed above.

Some concepts in ML-based language models are now discussed. It may be noted that, while the term “language model” has been commonly used to refer to a ML-based language model, there could exist non-ML language models. In the present disclosure, the term “language model” may be used as shorthand for ML-based language model (i.e., a language model that is implemented using a neural network or other ML architecture), unless stated otherwise. For example, unless stated otherwise, “language model” encompasses LLMs.

A language model may use a neural network (typically a DNN) to perform natural language processing (NLP) tasks such as language translation, image captioning, grammatical error correction, and language generation, among others. A language model may be trained to model how words relate to each other in a textual sequence, based on probabilities. A language model may contain hundreds of thousands of learned parameters or in the case of a large language model (LLM) may contain millions or billions of learned parameters or more.

In recent years, there has been interest in a type of neural network architecture, referred to as a transformer, for use as language models. For example, the Bidirectional Encoder Representations from Transformers (BERT) model, the Transformer-XL model and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

FIG. 1B is a simplified diagram of an example transformer 50, and a simplified discussion of its operation is now provided. The transformer 50 includes an encoder 52 (which may comprise one or more encoder layers/blocks connected in series) and a decoder 54 (which may comprise one or more decoder layers/blocks connected in series). Generally, the encoder 52 and the decoder 54 each include a plurality of neural network layers, at least one of which may be a self-attention layer. The parameters of the neural network layers may be referred to as the parameters of the language model.

The transformer 50 may be trained on a text corpus that is labelled (e.g., annotated to indicate verbs, nouns, etc.) or unlabelled. LLMs may be trained on a large unlabelled corpus. Some LLMs may be trained on a large multi-language, multi-domain corpus, to enable the model to be versatile at a variety of language-based tasks such as generative tasks (e.g., generating human-like natural language responses to natural language input).

An example of how the transformer 50 may process textual input data is now described. Input to a language model (whether transformer-based or otherwise) typically is in the form of natural language as may be parsed into tokens. It should be appreciated that the term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph, etc.) into a sequence of shorter segments that are converted to numerical representations referred to as tokens (or “compute tokens”). Typically, a token may be an integer that corresponds to the index of a text segment (e.g., a word) in a vocabulary dataset. Often, the vocabulary dataset is arranged by frequency of use. Commonly occurring text, such as punctuation, may have a lower vocabulary index in the dataset and thus be represented by a token having a smaller integer value than less commonly occurring text. Tokens frequently correspond to words, with or without whitespace appended. In some examples, a token may correspond to a portion of a word. For example, the word “lower” may be represented by a token for [low] and a second token for [er]. In another example, the text sequence “Come here, look!” may be parsed into the segments [Come], [here], [,], [look] and [!], each of which may be represented by a respective numerical token. In addition to tokens that are parsed from the textual sequence (e.g., tokens that correspond to words and punctuation), there may also be special tokens to encode non-textual information. For example, a [CLASS] token may be a special token that corresponds to a classification of the textual sequence (e.g., may classify the textual sequence as a poem, a list, a paragraph, etc.), a [EOT] token may be another special token that indicates the end of the textual sequence, other tokens may provide formatting information, etc.

In FIG. 1B, a short sequence of tokens 56 corresponding to the text sequence “Come here, look!” is illustrated as input to the transformer 50. Tokenization of the text sequence into the tokens 56 may be performed by some pre-processing tokenization module such as, for example, a byte pair encoding tokenizer (the “pre” referring to the tokenization occurring prior to the processing of the tokenized input by the LLM), which is not shown in FIG. 1B for simplicity. In general, the token sequence that is inputted to the transformer 50 may be of any length up to a maximum length defined based on the dimensions of the transformer 50 (e.g., such a limit may be 2048 tokens in some LLMs). Each token 56 in the token sequence is converted into an embedding vector 60 (also referred to simply as an embedding). An embedding 60 is a learned numerical representation (such as, for example, a vector) of a token that captures some semantic meaning of the text segment represented by the token 56. The embedding 60 represents the text segment corresponding to the token 56 in a way such that embeddings corresponding to semantically-related text are closer to each other in a vector space than embeddings corresponding to semantically-unrelated text. For example, assuming that the words “look”, “see”, and “cake” each correspond to, respectively, a “look” token, a “see” token, and a “cake” token when tokenized, the embedding 60 corresponding to the “look” token will be closer to another embedding corresponding to the “see” token in the vector space, as compared to the distance between the embedding 60 corresponding to the “look” token and another embedding corresponding to the “cake” token. The vector space may be defined by the dimensions and values of the embedding vectors. Various techniques may be used to convert a token 56 to an embedding 60. For example, another trained ML model may be used to convert the token 56 into an embedding 60. In particular, another trained ML model may be used to convert the token 56 into an embedding 60 in a way that encodes additional information into the embedding 60 (e.g., a trained ML model may encode positional information about the position of the token 56 in the text sequence into the embedding 60). In some examples, the numerical value of the token 56 may be used to look up the corresponding embedding in an embedding matrix 58 (which may be learned during training of the transformer 50).

The generated embeddings 60 are input into the encoder 52. The encoder 52 serves to encode the embeddings 60 into feature vectors 62 that represent the latent features of the embeddings 60. The encoder 52 may encode positional information (i.e., information about the sequence of the input) in the feature vectors 62. The feature vectors 62 may have very high dimensionality (e.g., on the order of thousands or tens of thousands), with each element in a feature vector 62 corresponding to a respective feature. The numerical weight of each element in a feature vector 62 represents the importance of the corresponding feature. The space of all possible feature vectors 62 that can be generated by the encoder 52 may be referred to as the latent space or feature space.

Conceptually, the decoder 54 is designed to map the features represented by the feature vectors 62 into meaningful output, which may depend on the task that was assigned to the transformer 50. For example, if the transformer 50 is used for a translation task, the decoder 54 may map the feature vectors 62 into text output in a target language different from the language of the original tokens 56. Generally, in a generative language model, the decoder 54 serves to decode the feature vectors 62 into a sequence of tokens. The decoder 54 may generate output tokens 64 one by one. Each output token 64 may be fed back as input to the decoder 54 in order to generate the next output token 64. By feeding back the generated output and applying self-attention, the decoder 54 is able to generate a sequence of output tokens 64 that has sequential meaning (e.g., the resulting output text sequence is understandable as a sentence and obeys grammatical rules). The decoder 54 may generate output tokens 64 until a special [EOT] token (indicating the end of the text) is generated. The resulting sequence of output tokens 64 may then be converted to a text sequence in post-processing. For example, each output token 64 may be an integer number that corresponds to a vocabulary index. By looking up the text segment using the vocabulary index, the text segment corresponding to each output token 64 can be retrieved, the text segments can be concatenated together and the final output text sequence (in this example, “Viens ici, regarde!”) can be obtained.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that may be considered to be an encoder-only language model. A decoder-only language model accepts embeddings as input and may use auto-regression to generate an output text sequence. Transformer-XL and GPT-type models may be language models that are considered to be decoder-only language models.

Because GPT-type language models tend to have a large number of parameters, these language models may be considered LLMs. An example GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2048 input tokens), and is able to generate a large number of tokens as output (e.g., up to 2048 tokens). GPT-3 has been trained as a generative model, meaning that it can process input text sequences to predictively generate a meaningful output text sequence. ChatGPT is built on top of a GPT-type LLM, and has been fine-tuned with training datasets based on text-based chats (e.g., chatbot conversations). ChatGPT is designed for processing natural language, receiving chat-like inputs and generating chat-like outputs.

A computing system may access a remote language model (e.g., a cloud-based language model), such as ChatGPT or GPT-3, via a software interface (e.g., an application programming interface (API)). Additionally or alternatively, such a remote language model may be accessed via a network such as, for example, the Internet. In some implementations such as, for example, potentially in the case of a cloud-based language model, a remote language model may be hosted by a computer system as may include a plurality of cooperating (e.g., cooperating via a network) computer systems such as may be in, for example, a distributed arrangement. Notably, a remote language model may employ a plurality of processors (e.g., hardware processors such as, for example, processors of cooperating computer systems). Indeed, processing of inputs by an LLM may be computationally expensive/may involve a large number of operations (e.g., many instructions may be executed/large data structures may be accessed from memory) and providing output in a required timeframe (e.g., real-time or near real-time) may require the use of a plurality of processors/cooperating computing devices as discussed above.

Inputs to an LLM may be referred to as a prompt, which is a natural language input that includes instructions to the LLM to generate a desired output. A computing system may generate a prompt that is provided as input to the LLM via its API. As described above, the prompt may optionally be processed or pre-processed into a token sequence prior to being provided as input to the LLM via its API. A prompt can include one or more examples of the desired output, which provides the LLM with additional information to enable the LLM to better generate output according to the desired output. Additionally or alternatively, the examples included in a prompt may provide inputs (e.g., example inputs) corresponding to/as may be expected to result in the desired outputs provided. A one-shot prompt refers to a prompt that includes one example, and a few-shot prompt refers to a prompt that includes multiple examples. A prompt that includes no examples may be referred to as a zero-shot prompt.

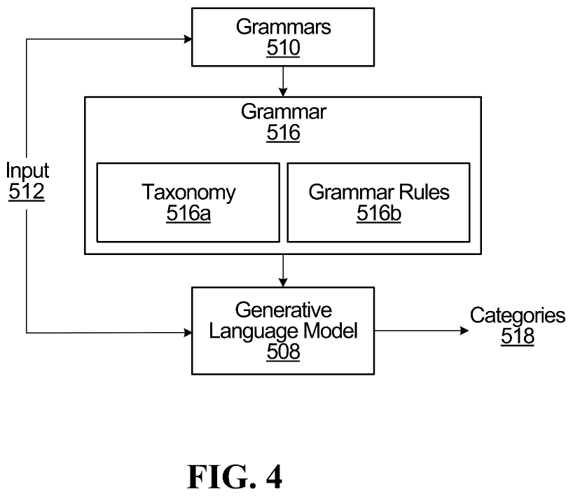

FIG. 2 illustrates an example computing system 400, which may be used to implement examples of the present disclosure, such as a prompt generation engine to generate prompts to be provided as input to a language model such as a LLM. Additionally or alternatively, one or more instances of the example computing system 400 may be employed to execute the LLM. For example, a plurality of instances of the example computing system 400 may cooperate to provide output using an LLM in manners as discussed above.

The example computing system 400 includes at least one processing unit, such as a processor 402, and at least one physical memory 404. The processor 402 may be, for example, a central processing unit, a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, or combinations thereof. The memory 404 may include a volatile or non-volatile memory (e.g., a flash memory, a random access memory (RAM), and/or a read-only memory (ROM)). The memory 404 may store instructions for execution by the processor 402, to the computing system 400 to carry out examples of the methods, functionalities, systems and modules disclosed herein.

The computing system 400 may also include at least one network interface 406 for wired and/or wireless communications with an external system and/or network (e.g., an intranet, the Internet, a P2P network, a WAN and/or a LAN). A network interface may enable the computing system 400 to carry out communications (e.g., wireless communications) with systems external to the computing system 400, such as a language model residing on a remote system.

The computing system 400 may optionally include at least one input/output (I/O) interface 408, which may interface with optional input device(s) 410 and/or optional output device(s) 412. Input device(s) 410 may include, for example, buttons, a microphone, a touchscreen, a keyboard, etc. Output device(s) 412 may include, for example, a display, a speaker, etc. In this example, optional input device(s) 410 and optional output device(s) 412 are shown external to the computing system 400. In other examples, one or more of the input device(s) 410 and/or output device(s) 412 may be an internal component of the computing system 400.

A computing system, such as the computing system 400 of FIG. 2, may access a remote system (e.g., a cloud-based system) to communicate with a remote language model or LLM hosted on the remote system such as, for example, using an application programming interface (API) call. The API call may include an API key to enable the computing system to be identified by the remote system. The API call may also include an identification of the language model or LLM to be accessed and/or parameters for adjusting outputs generated by the language model or LLM, such as, for example, one or more of a temperature parameter (which may control the amount of randomness or “creativity” of the generated output) (and/or, more generally some form of random seed as serves to introduce variability or variety into the output of the LLM), a minimum length of the output (e.g., a minimum of 10 tokens) and/or a maximum length of the output (e.g., a maximum of 1000 tokens), a frequency penalty parameter (e.g., a parameter which may lower the likelihood of subsequently outputting a word based on the number of times that word has already been output), a “best of” parameter (e.g., a parameter to control the number of times the model will use to generate output after being instructed to, e.g., produce several outputs based on slightly varied inputs). The prompt generated by the computing system is provided to the language model or LLM and the output (e.g., token sequence) generated by the language model or LLM is communicated back to the computing system. In other examples, the prompt may be provided directly to the language model or LLM without requiring an API call. For example, the prompt could be sent to a remote LLM via a network such as, for example, as or in message (e.g., in a payload of a message).

### Grammar-Constrained Generative Language Model Employed as a Classifier

A typical classifier is “trained” on a training data set, which may include inputs and labels. The trained classifier may be configured to identify the likelihood that an input belongs to one or more classifications or categories (e.g. within a taxonomy). The classifications may correspond with the labels used in the training stage.

For example, a typical classifier may be trained on images of clothing items and, for each image, one or more labels indicating the type of clothing item, such as a shoe, pants and a shirt. Once trained, the trained classifier may receive an image and may output an indication that the image depicts one of a shoe, pants or a shirt.

In one implementation, given an input image depicting a shoe, the classifier may output a high likelihood that the image is a shoe, as well as probabilities indicating whether the input image is a pant or a shirt, respectively.

In alternative implementations, the typical classifier may be configured to output only a single classification of the input, such as indicating that the input image depicts a shoe. The single classification may be accompanied with a confidence value, indicating the classifier's confidence in the classification.

However, it will be appreciated that typical classifiers must be trained on a large input sample to accurately classify inputs. For example, if a classifier is trained to classify elements in an image with 128 pixels, a large sample size may be required for the classifier to accurately classify based on this limited information. A typical classifier is not provided with additional context to help classify the image beyond the 128 pixels.

In addition, if a new classification category needs to be added to a taxonomy after the classifier has already been trained to classify within the taxonomy, the classifier must be recreated and retrained to classify within the updated taxonomy. Similarly, a separate classifier may be needed to classify each separate taxonomy, i.e. a first classifier may be needed to classify clothing items and a second classifier may be needed to classify brands of cars. Typical classifiers may thus pose scaling challenges.

One possible solution to these problems is to use a generative language model to perform classification. An example of a generative language model is a large language model (LLM), e.g. the LLM described earlier in relation to FIG. 1B. If classifying clothing items, the LLM may be provided with an image and asked whether the image depicts a shoe, pants or a shirt. If classifying something else, such as car brands, the LLM may be asked what car brand is depicted in the image.

One benefit of using an LLM as a classifier is that it may not need to be trained on a data set corresponding to the specific classification task. For example, the LLM classifier may not need to be trained on the data set described above, such as images of clothing and corresponding labels indicating the type of clothing item. An LLM classifier may be used which was instead trained on a more generic data set, such as a large corpus of text and images. As well, this may allow the same LLM classifier to be used to classify different taxonomies, e.g. clothing items and car brands.

Although the term LLM classifier is used throughout this document, the solution described in this document may use either an LLM or, more generally, a general generative language model. An LLM is an example of a generative language model.

In some examples, the LLM may be multi-modal, such as BLIP or GPT-4V.

The LLM classifier may be “prompted” with an input (e.g. an input element, such as text and/or an image) to classify. As in the previous example, the input may be an image, which may depict a shoe. The input may also be text or some other data, and may also include multiple types of data, such as an image and text. The prompt may also include text asking the LLM classifier to output a classification of the input. For example, the prompt text may ask the LLM classifier to determine whether the image in the prompt depicts a shoe, pants or a shirt. In other examples, the prompt text may not explicitly identify the categories within which the LLM classifier is asked to categorize the image. In further examples, unlike typical classifiers which only classify based on input, such as the 128 pixels of an image, the LLM classifier may also receive additional context from the prompt to aid with classification.

The LLM may provide an output indicating the classification or category within which the prompt may be classified or categorized. In the examples provided above, the LLM may identify whether the image depicts a shoe, pants or a shirt.

However, generative language models are designed for text generation of a general nature. Unlike conventional machine learning classifiers, generative language models are not dedicated or even optimized for classification. One problem of generative language models compared to conventional machine learning classifiers is that they have a tendency to “hallucinate,” such that they provide an output that is incorrect or not relevant to the input into the LLM. Hallucination is a technical problem that can occur because of factors such as incomplete training or fine-tuning of the LLM. In one example, hallucinations result when, during training of the LLM, an encoder of the LLM learns wrong correlations between different parts of the training data. One example of hallucination is as follows. An LLM provided with a prompt, including text and an image depicting a shoe, may provide an output indicating that the image depicts a stiletto or high-heels, rather than a shoe or one of the other predefined categories. It may also output text completely unrelated to the prompt.

To address the problem described above, a generative language model may be modified so that it can only generate an output that classifies the input into one of the predefined categories of the taxonomy. This may be implemented by employing a grammar. The grammar may define valid sequences of output (e.g. valid sequences of symbols) corresponding to a plurality of categories. The input can be classified into one or more of the plurality of categories. For example, the grammar may include symbols, such as text, identifying or delineating the plurality of categories. The plurality of categories may be the classifier taxonomy, e.g. the predefined categories of the classification. Following the examples provided above, the grammar may include (or define) the taxonomy of clothing items, namely a shoe, pants and a shirt.

Note that the term “symbols”, as used herein, encompasses tokens, text (such as segments or chunks of text), characters, or numerical representations thereof. For example, a token generated by an LLM is an example of a symbol. A sequence of more than one token may also be an example of a symbol. As another example, a numerical representation of one or more characters or segments of text, such as American standard code for information interchange (ASCII) or Unicode is an example of a symbol. A unit of output of an LLM either before or after post-processing is an example of a symbol.

As the LLM generates an output in response to an input prompt, the LLM classifier may constrain the output of the LLM to conform to the language or syntax specified in the grammar. For example, the LLM classifier may use the grammar to constrain token prediction by the LLM. The LLM classifier may use the grammar to provide an output from the LLM that is constrained to the classifier taxonomy. In other words, the grammar may be used to restrict the LLM to classify inputs within a taxonomy specified by the grammar. The grammar may also be used to limit the list of tokens that can be predicted by the LLM for a given input.

In some implementations, the grammar may be enforced using the techniques described in co-pending, co-owned U.S. patent application Ser. No. 18/512,781 filed Nov. 17, 2023 entitled “GENERATION OF GRAMMAR-COMPLIANT PROGRAMMING LANGUAGE CODE USING MACHINE LEARNING”, the contents of which are herein incorporated by reference.

As noted above, the LLM classifier may generate, using the LLM, a sequence of symbols identifying the one or more categories identified or delineated by the grammar. In some implementations, the LLM classifier may refer to the grammar as the LLM generates symbols, such as output tokens. If the LLM is predicting the next token in an output sequence, it may need to choose between a first token and a second token. Although the first token may have a higher probability of being selected by the LLM than the second token, such that a conventional LLM would select the first token rather than the second token, the first token may not be included within or permitted by the grammar given the previously generated token(s). However, the second output token may be included within and/or permitted by the grammar. Consequently, the grammar may be used to constrain the selection of the next token in the output sequence, such that the LLM classifier may select the second token over the first token, even though, without the grammar, the second token has a lower probability of being selected by the LLM than the first token. Since the second token is specified within the grammar, it may help the LLM classifier avoid hallucinating and help ensure the classifier generates an output within the classifier taxonomy.

In some implementations, the grammar may be enforced using a mask. In particular, the LLM may output a plurality of values which each indicate a probability for a respective token being a next token in the token sequence generated by the LLM classifier. In the example above, the LLM classifier may need to predict between the first token and the second token. The first token and the second token may each be associated with a probability for that token being predicted as the next token. A mask may be applied to the plurality of values. The mask may operate on each value that corresponds to a token not compliant with the grammar to reduce or zero the probability of the token being the next token. In the example above, the probability that the first token may be selected may be reduced or set to zero, while the probability that the second token may be selected may not be affected (or may be increased so that the probabilities of all valid next tokens add up to one). The LLM may determine the next token based on the plurality of values after the mask is applied.

In an example of these implementations, the LLM classifier may output a tensor that includes the plurality of values (e.g. in a final layer of a neural network of the LLM), in which case each value of the plurality of values may represent an unnormalized probability that the token corresponding to that value is the next token. The mask may be another tensor, and applying the mask may be implemented by performing a tensor product of the two tensors or the equivalent, to modify the value of each token not compliant with the grammar to reduce or zero the probability of that token being selected. In another example, the plurality of values may be a plurality of normalized probability values output from a softmax function of the LLM, and the mask may be applied at that point, e.g. to set to zero probability each of the normalized probability values that corresponds to a token not compliant with the grammar.

In some implementations, the grammar may be retrieved as the LLM receives an input prompt or begins predicting tokens. For example, the input prompt may ask the LLM classifier to determine what clothing item is depicted in the prompt image. After receiving the prompt, the LLM classifier may retrieve a grammar associated with the clothing item taxonomy or may dynamically generate the grammar.

In other implementations, the grammar may be dynamically generated in response to a specific input prompt. For example, after receiving the input prompt asking the LLM classifier to determine what clothing item is depicted in the prompt image, the LLM classifier may dynamically generate a grammar associated with the clothing item taxonomy. Dynamically generating the grammar may include retrieving taxonomy information associated with clothing items from a database and saving that information within the grammar. In some implementations, the categories may be provided in the input prompt and used to generate the grammar.

In some implementations, the grammar may include a label representative of the plurality of categories to which the grammar relates. The input prompt may include an instruction including information associated with one or more categories. The grammar may be obtained based on the instruction. For example, obtaining the grammar may include determining that the instruction is associated with the label and selecting the grammar from a set of one or more grammars.

In some examples, the grammar may be generated from a template. The template may specify a format of the grammar.

In some examples, the grammar may be formatted such that it may be parsed by the LLM classifier, such as in a markup language. The markup language may be JSON.

It will be appreciated that unlike typical classifiers, the LLM classifier may be reconfigured to classify an updated taxonomy possibly without retraining or fine-tuning. This may reduce the consumption of computing resources, as well as improve computing speed and efficiency. For example, if a new category is added to the classifier taxonomy, only the grammar needs to be updated. Once that is complete, the LLM classifier may be able to classify input prompts within the updated taxonomy.

In addition, the LLM classifier may be used to classify different taxonomies possibly without retraining or fine-tuning. This may also result in a reduction in the consumption of computing resources, as well as an improvement in computing speed and efficiency. In some implementations, the LLM classifier may include or be configured to use (and/or possibly generate) more than one grammar, wherein each grammar is associated with a different taxonomy. For example, the LLM classifier may include a first grammar associated with clothing items and a second grammar associated with automobile brands. The LLM classifier may also be configured to dynamically generate the first grammar and/or the second grammar depending on the input prompt. The LLM classifier may either retrieve or dynamically generate one of the first grammar or the second grammar depending on the input prompt into the LLM classifier.

It will also be appreciated that in applications involving LLMs but where a classifier is needed, it may be advantageous to use only an LLM rather than an LLM and a separate classifier. This may also simplify the computing architecture, as well as reduce networking constraints and the computing resources needed for training a separate classifier.

The LLM classifier may output an indication of the one or more categories into which the input has been classified based on the sequence of symbols. In some implementations, the sequence of symbols, when mapped to text, may provide a written indication of the one or more categories.

In some implementations, the LLM classifier may output one or more probabilities associated with the one or more categories into which the input has been classified based on the sequence of symbols.

In further implementations, the LLM classifier may output programming language code. For example, the programming language code may indicate the one or more categories into which the input has been classified based on the sequence of symbols by the LLM classifier. The programming language code may be either a markup language, which may be parsed by another language or executable programming language code. The executable programming language code may be used by another system to perform further processing based on the one or more categories into which the input has been classified. In one example, the LLM outputs an indication of one or more categories, but in a JSON format, e.g. using JSON syntax. That is, the grammar constrains the output to the predefined categories and also constrains the output to have a JSON format.

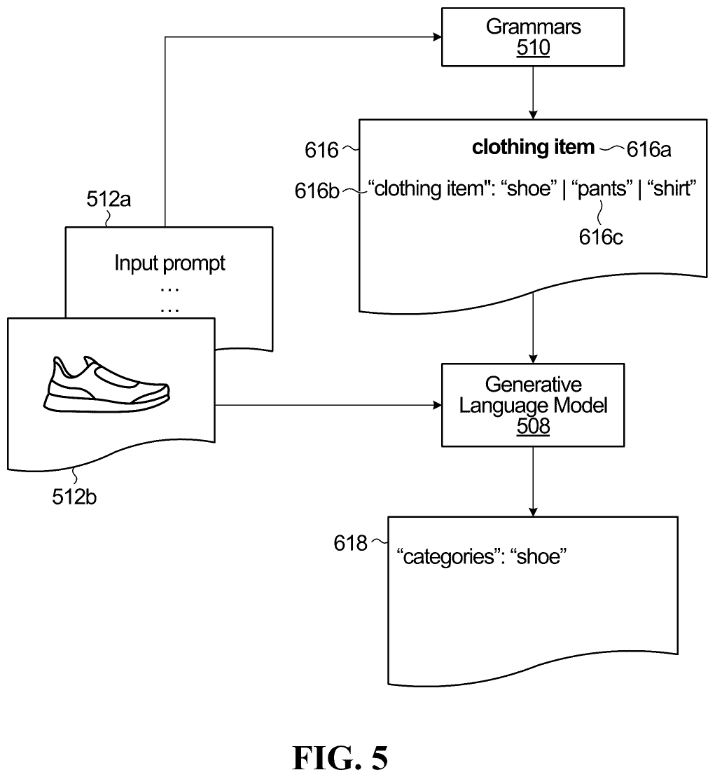

FIG. 3 illustrates an example of a system 500. System 500 may be used to classify or categorize an input. It will be appreciated that the term “classify”, as used herein, is interchangeable with the term “categorize”, as used herein.

System 500 includes a memory 502 and one or more processors 504. Memory 502 includes a generative language model 508. By “storing” generative language model 508, it is meant that the parameters and other values that make up generative language model 508 and that are required for execution of generative language model 508 are stored. The parameters depend upon how generative language model 508 is implemented. For example, assuming generative language model 508 utilizes one or more neural networks, the weights and biases of the one or more neural networks are stored.

Generative language model 508 may have been trained on a generic data set, such as a large corpus of text, images or other data. Generative language model 508 may be an LLM. The LLM may have the example LLM structure described earlier in relation to FIG. 1B, or it may have another structure, e.g. it may only implement a decoder or an encoder, rather than both. The exact structure of the LLM is implementation specific.

One or more processors 504 may execute generative language model 508. One or more processors 504 may each be implemented as a processor that executes instructions stored in memory, or it/they may be or include dedicated integrated circuits, such as one or more field programmable gate arrays (FPGAs) and/or one or more application-specific integrated circuits (ASICs). One or more processors 504 may be or include one or more processing cores. One or more processors 504 may be or include one or more processing cores on a GPU.

Memory 502 further stores grammars 510. In some implementations, grammars 510 may include one or more grammars stored in memory, such as one or more grammar files. In other implementations, grammars 510 may be used to obtain one or more grammars from memory 502 or some other memory. Grammars 510 may also be used to obtain one or more grammars from a database. In further implementations, grammars 510 may be used to generate one or more grammars. For example, grammars 510 may include instructions for generating one or more grammars, and one or more processors 504 may execute the instructions to generate the one or more grammars.

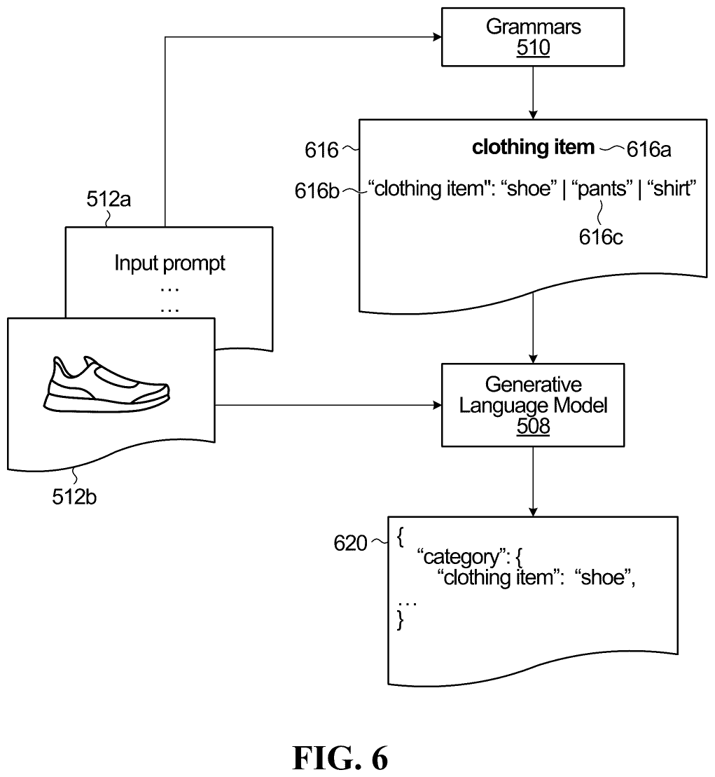

FIG. 4 depicts an example of applying system 500 to classify or categorize an input 512. System 500 may be “prompted” with input 512, which may include text, an image or both. It will be appreciated that input 512 may include multiple types of data, such as an image and text. For example, input 512 may include an image and prompt text. The prompt text may ask system 500 to classify or categorize input 512. In some implementations, the prompt text may ask system 500 to classify what is depicted in the image. The prompt text may also identify a taxonomy or set of categories for what is depicted within the image. In other examples, the prompt text may not explicitly identify any possible categories for what is depicted within the image.

In further implementations, input 512 may also or instead include other forms of data, such as videos, databases, computer objects and other formats of data.

It will be appreciated that system 500, including generative language model 508, may be multi-modal.

Input 512 may be received by grammars 510. Grammars 510 may use input 512 to obtain grammar 516 associated with input 512. In particular, grammars 510 may obtain grammar 516 responsive to input 512, such as some aspect or a textual instruction within input 512.

Grammar 516 may define valid sequences of symbols corresponding to (e.g. defining, delineating, identifying, describing etc.) categories, classifications or a taxonomy. In some examples, grammar 516 may define valid sequences of symbols according a syntax of a domain-specific language within which input 512 may be classified.

Grammar 516 may be associated with a taxonomy 516a and include one or more grammar rules 516b. In some implementations, grammar 516 may be associated with input 512 and include one or more grammar rules 516b associated with input 512 or some aspect of input 512. For example, grammar 516 may define valid sequences of output (e.g. valid sequences of symbols) classifying input 512 into one or more classifications or categories. For example, grammar 516 may include symbols, such as text, identifying or delineating categories or classifications within a taxonomy 516a. In some further examples, grammar 516 may be associated with more than one taxonomy 516a, and grammar 516 may include symbols, such as text, identifying or delineating the categories or classifications within the one or more taxonomies.

As used herein, the term “taxonomy” refers to one or more classifications or a plurality of categories that are associated with one another or may be grouped together. For example, taxonomy 516a may be “clothing items” and may include the following categories or classifications: “shoe”, “pants” and “shirt”. Categories within a taxonomy 516a may or may not be mutually exclusive with one another. That is, in some examples, if an element is classified as “pants” it may not be also classified as “shoe” or “shirt”. However, in some examples, an element may be classified within multiples categories, such classifying coveralls as both “pants” and “shirt”.

Note that the term “symbols”, as used herein, encompasses tokens, text (such as segments or chunks of text), characters, or numerical representations thereof. For example, a token generated by an LLM is an example of a symbol. A sequence of more than one token may also be an example of a symbol. As another example, a numerical representation of one or more characters or segments of text, such as American standard code for information interchange (ASCII) or Unicode is an example of a symbol. A unit of output of an LLM either before or after post-processing is an example of a symbol.

Grammar 516 may be obtained from memory, such as memory 502 or some other memory. In some examples, input 512 may include an instruction and grammar 516 may be obtained based on the instruction. For example, grammar 616 may be identified in memory by matching or partially matching the instruction with taxonomy 616a. In further examples, grammar 516 may be obtained from a database based on input 512, such as the instruction or some other aspect of input 512.

In some implementations, grammar 516 may be downloaded from a server. Grammar 516 may be downloaded as one or more grammar files. In this case where more than one grammar file is downloaded, the grammar files be combined into grammar 516. In these implementations, grammars 510 may only be accessible over a network, such as a local network or the Internet. Grammars 510 may be a data server, a website, a database, an Application Programming Interface (API) or some other entity accessible over a network. Alternatively, grammars 510 may download the one or more grammar files from a separate data server, website, database, or some other entity over a network or through an API.

In other implementations, grammars 510 may use input 512 to generate grammar 516. Grammar 516 may be generated dynamically by grammars 510. For example, a database may store classification or category information associated with some aspect of input 512. In one example, the database may store taxonomy 516a and grammar rules 516b. Taxonomy 516a may be indicated within input 512, such as within a textual prompt of input 512. The category information, including taxonomy 516a and grammar rules 516b, may be retrieved from the database and encoded within grammar 516. The category information may be retrieved based on an instruction within input 512, for example. The encoding may be in a format for parsing, such as a mark-up language. The mark-up language may be JSON. It will be appreciated that grammar 516 may be encoded within a file, such as a grammar file.

It will also be appreciated that when grammar is obtained, such as when grammar is generated, grammar 516 may be encoded within a file, such as a grammar file. In this example, grammar rules 616b may be encoded within a file. Taxonomy 616a may also be encoded within the file. However, in some examples, taxonomy 616a may not be encoded within the file and the grammar file may instead be associated with taxonomy 616a, such as by naming the file after taxonomy 616a or associating the file with taxonomy 616a in metadata, in memory or in a database.

In alternative implementations, grammar 516 is not obtained based on or responsive to input 512. Instead, grammar 516 may be predefined, such that system 500, and in particular generative language model 508, may be dedicated to a certain type of classification or taxonomy 516a and may only enforce the one grammar 516.

In some implementations, more than one grammar may be obtained from grammars 510. Some or all of the more than one grammars may be obtained from different sources, e.g. from memory, from a database, over a network or downloaded, and/or dynamically generated. In some examples, the more than one grammars may be combined into grammar 516.

Input 512 and grammar 516 may be transmitted to generative language model 508. As noted above, generative language model 508 may be an LLM. Generative language model 508 may generate an indication of one or more categories 518 into which input 512 has been classified. To ensure that generative language model 508 describes categories 518 within taxonomy 516a, into which input 512 may be classified, generative language model 508 may be constrained by grammar 516. Categories 518 may thus only include categories or classifications permitted by grammar 516, such as categories within taxonomy 516a and permitted by grammar rules 516b.

As will be described in more detail below, in some implementations grammar 516 may be used with generative language model 508 to constrain token prediction by generative language model 508. In particular, token prediction may be constrained by grammar rules 516b within grammar 516, such that categories 518 may more accurately categorize or classify input 512. Categories 518 may be based on a sequence of symbols generated by generative language model 508. As well, constraining token prediction by generative language model 508 with grammar 516 may help prevent hallucination.

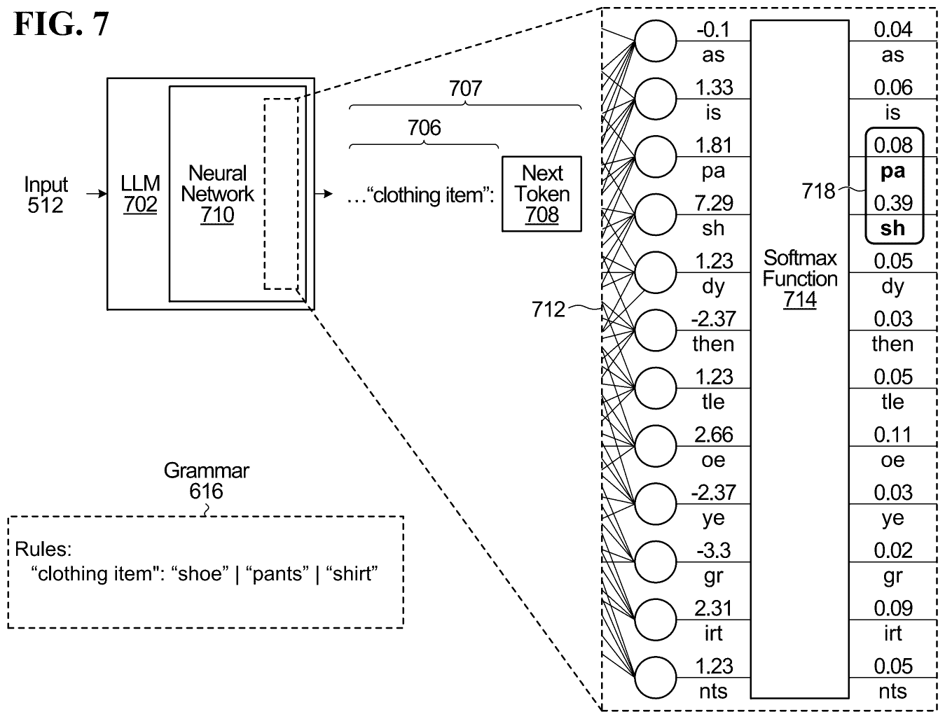

FIG. 5 depicts a further example of applying system 500 to an input 512. In the depicted example, input 512 includes an input prompt 512a and an image 512b. Input prompt 512a may be text, another type of data or a combination of multiple types of data. Image 512b may depict a shoe, such as a black shoe.

Input prompt 512a may include text asking system 500 to classify what is depicted within image 512b. For example, the input prompt 512a may ask system 500 categorize image 512b or categorize some aspect of what is depicted within image 512b. Input prompt 512a may also identify that image 512b depicts a “clothing item” and may identify a plurality of categories within that taxonomy, e.g. “shoe”, “shirt” and “pants” within which image 512b may be categorized. In other examples, input prompt 512a may not explicitly identify any possible categories for what is depicted within image 512b. In some further examples, input prompt 512a may also not identify the name of a specific taxonomy.

Grammars 510 may obtain grammar 516 responsive to input 512. For example, input 512 may be input to grammars 510 and used to obtain grammar 516, such as to retrieve or generate grammar 516, as already described above. In other examples, grammars 510 may simply obtain grammar 516 response to receiving input 512, without using input 512 as an input into grammars 510. In this depicted example, grammars 510 may obtain grammar 616 responsive to input 512.

Grammar 616 may be associated with a taxonomy 616a, such as “clothing item”, and include one or more grammar rules 616b, such as “clothing item”: “shoe” | “pants” | “shirt”, which may be stored or encoded within grammar 616. The grammar rules 616b may specify a plurality of categories 616c within taxonomy 616a. In the depicted example, the plurality of categories 616c are “shoe”, “pants” and “shirt” within taxonomy 616a (“clothing item”).

Grammar 616 may be stored or encoded in a format for parsing, such as a mark-up language. The mark-up language may be JSON. It will be appreciated that grammar 616 may be stored or encoded within a file, such as a grammar file. For example, grammar rules 616b may be stored or encoded within the grammar file. In some examples, taxonomy 616a may also be encoded within the grammar file, while in other examples taxonomy 616a may not be stored or encoded within the grammar file.

In some implementations, only input prompt 512a may be input to grammars 510. Grammars 510 may retrieve grammar 616 responsive to receiving input prompt 512a. This may reduce computing resources and/or processing time, since image 512b may not need to be transmitted to grammars 510. In some examples, input prompt 512a may include an instruction. Grammar 616 may be obtained responsive or in response to grammars 510 receiving instruction within input prompt 512a. The instruction may, for example, indicate taxonomy 616a within which image 512b should be classified. For example, the instruction may indicate the name of taxonomy 616a (e.g. “clothing item”) and/or list plurality of categories 616c within taxonomy 616a (e.g. “shoes”, “pant”, “shirt”). In some examples, grammars 616 may retrieve grammar 616 from memory, such as from memory 502, a database or some other memory, or may dynamically generate grammar 616 based on input prompt 512a.

In other implementations, only image 512b may be transmitted to grammars 510, and grammars 510 may obtain grammar 616 responsive to receiving image 512b. For example, grammar 616 may be obtained based on the data type of image 512b. It will be understood that in some examples, input 512 may include one or more data types instead of or in addition to an image, and grammar 616 may be obtained responsive to those one or more data types. In other examples, grammar 616 may be obtained based on some algorithmic analysis of image 512b, such as image recognition, edge detection, color detection or some other analysis by grammars 510 to determine the taxonomy associated with image 512b.

In further implementations, both input prompt 512a and image 512b may be transmitted to grammars 510, and grammars 510 may obtain grammar 616 responsive to receiving input prompt 512a and image 512b. Grammar 616 may be obtained based on some combination of the implementations described above.

Input 512 may be input to generative language model 508. Generative language model 508 may categorize input 512. In addition, to ensure that generative language model 508 categorizes input 512 within taxonomy 616a, such as within one or more categories 518 within taxonomy 616a (e.g. within the category “shoe” within the “clothing item” taxonomy), generative language model 508 may be constrained by grammar 616. Categories 618 may thus only include categories permitted by grammar 616 and, in particular, by grammar rules 616b.

In the depicted example, grammar 616 may be used to constrain generative language model 658 such that it only classifiers or categories input 512, such as image 512b, within categories permitted by grammar rules 616b. Categories 618 may thus only include categories within the taxonomy “clothing item”, such as “shoe”, “pants” and/or “shirt”.

Categories 618 may be based on a sequence of symbols generated by generative language model 508, as will be described in more detail below.

In some further examples, grammar 616 may also be used to prevent generative language model 508 from categorizing input 512 within categories not within taxonomy 616a or from indicating classifications or categories for input 512 that are not specified by grammar 616 within grammar rules 616b. In the depicted example, grammar 616 may prevent generative language model 508 from categorizing input 512 within categories outside “shoe”, “pants” and “shirt” or indicating classifications or categories for input 512 other than these categories.

In some implementations, only image 512b may be input to generative language model 508, in addition to grammar 616. Generative language model 508 may classify image 512b within taxonomy 616a, such as within one or more categories 518 permitted by grammar rules 616b. In the depicted example, generative language model 508 may classify image 512b within categories 618. Categories 618 may be “shoe”, indicating that image 512b depicts a shoe. In some other examples, generative language model 508 may classify image 512b within more than one category, such that image 512b is associated with multiple categories 518.

In other implementations, both input prompt 512a and image 512b may be input to generative language model 508, in addition to grammar 616. Generative language model 508 may classify input 512 based on image 512b and some or all of input prompt 512a. For example, input prompt 512a may provide further context for classifying image 512b. Generative language model 508 may determine categories 618 by classifying the combination of image 512b and some or all of input prompt 512a. It will be appreciated that categories 618 will be permitted by grammar 616.

In some other examples, input prompt 512a may be used to indicate what type of model should be used to classify image 512b, such as indicating a type of generative language model or a generative language model trained on a certain corpus of data that should be used to classify image 512b. In these examples generative language model 508 may be retrieved based on input prompt 512a. Generative language model 508 may be retrieved from memory, such as memory 502, or some other data source. Input prompt 512a may in addition or instead be used to configure generative language model 508, such as by indicating certain parameters for generative training model 508. Generative language model 508, constrained by grammar 616, may then be used to classify image 512b to determine categories 518, such as categories 618. Alternatively, generative language model 508, constrained by grammar 616, may be used to classify the combination of image 512b and some or all of input prompt 512a.

In further implementations, only input prompt 512a and grammar 616 may be input to generative language model 508. Generative language model 508, constrained by grammar 616, may classify input 512 based on input prompt 512a and without image 512b, such as by classifying text within input prompt 512a. Categories 618 may be obtained from or based on this classification of input prompt 512 by generative language model 508. It will be appreciated that categories 618 will be permitted by grammar 616.

The format of categories 618 may be determined by grammar 616. As depicted in FIG. 5, the format of categories 618 may include the format [“taxonomy”]: [“category”]. This format, including the colon between taxonomy and category (or categories) and the quotation marks around the taxonomy and category (or categories), may also be specified by grammar 616. Alternatively or in addition, the format of categories 618 may also be determined by post-processing. Examples of post-processing may include converting tokens generated by generative language model 508 into a text sequence and/or re-formatting a sequence of tokens or a text sequence to conform to a specific format.

In some examples, generative language model 508 may generate formatted categories 620, as depicted in FIG. 6. As noted above, formatted categories 620 may be generated directly by generative language model 508, such as if grammar 616 specifies a format in its grammar rules 616b. Alternatively or in addition, formatted categories 620 may be generated based on categories 618 and/or some other output from generative language model 508 through post-processing.

Formatted categories 620 may include programming language code. For example, the programming language code may indicate one or more categories within taxonomy 616a within which input 512 has been classified. The programming language code may be either a markup language, which may be parsed by another language, or executable programming language code. The executable programming language code may be used by another system to perform further processing based on the one or more classifications or categories for input 512. In one example, generative language model 508 may output formatted categories 620 which include the category “shoe” within the taxonomy 616a (“clothing item”), as well as a pre-defined format. Formatted categories 620 may be partially or fully in a format for parsing. For example, formatted categories 620 may be partially or fully in JSON, i.e. in the JSON syntax (as depicted in FIG. 6). In this example, grammar 616 may constrain the output from generative language model 508 to the categories in grammar 616 (defined by grammar rules 616b) and also constrain the output to have a JSON format.

As discussed above, grammar 616 may be used to constrain generative language model 508 such that input 512 is classified into categories that are permitted by grammar 616, i.e. permitted by grammar rules 616b. Grammar 616 depicted in FIGS. 5 and 6 includes taxonomy 616a (e.g. “clothing item”) and grammar rules 616b defining categories (e.g. “shoe”, “pants” and “shirt”) permitted by grammar 616 to define valid sequences of output. Other examples of grammar rules may include rules that define how taxonomies, categories, and other characters can be arranged in relation to each other to define the valid sequences of output. For example, some additional grammar rules in grammar 616 (not depicted) may require taxonomies and categories to be specified in quotation marks and separated by a colon, as well as to be delineated by braces. Some grammar rules may also specify characters or longer expressions of text (e.g. sequences of characters) that are prohibited by the grammar and thus must not appear in the output.

The valid sequences of output from generative language model 508 are only those that follow the rules of grammar 616. For example, with the grammar 616, “clothing item”: “shoe” is an example of a valid statement, while “style”: “relaxed” and even “clothing item”: “purple” are examples of invalid statements. In some further examples, “clothing item”=“shoe” may be an invalid statement because it violates grammar rules dictating formatting with grammar 616 (not shown).

The example grammar 616 may thus be used to constrain the output of generative language model 508 to mitigate hallucination. Hallucination in the example depicted in FIG. 5 would be an incorrect categories 618 or formatted categories 620 that would not accurately describe input 512 (e.g. input image 512b).

Consider a simple example in which generative language model 508 can only generate the following tokens: as is pa sh dy then tle oe ye gr irt nts. This example is simplified for ease of explanation. In actuality, generative language model 508 would typically be able to generate thousands of different tokens. During operation, in response to input 512, generative language model 508 generates a token sequence consisting of multiple ones of some or all of these tokens output one after the other. In the explanations herein, each token is illustrated/described in the form of text, but it will be appreciated that in implementation the token may just be a number that, via post-processing, is mapped to corresponding text, e.g. mapped to a numerical representation of one or more characters or segments of text, such as American standard code for information interchange (ASCII) or Unicode. Each token may be equal to or a portion of a terminal symbol of the grammar, although more generally this need not be the case (e.g. generative language model 508 may be able to generate tokens that are not equal to or part of terminal symbols of the grammar).

Continuing the example introduced above, when generating a next token given the sequence of previous tokens, generative language model 508 can only select one of the following tokens as the next token: as is pa sh dy then tle oe ye gr irt nts. There may be a non-zero probability that the next token selected is one that, when appended onto the sequence, results in an invalid statement in categories 618 classifying input 512, i.e. causes the sequence to not be compliant with the valid sequences of output defined by the grammar.

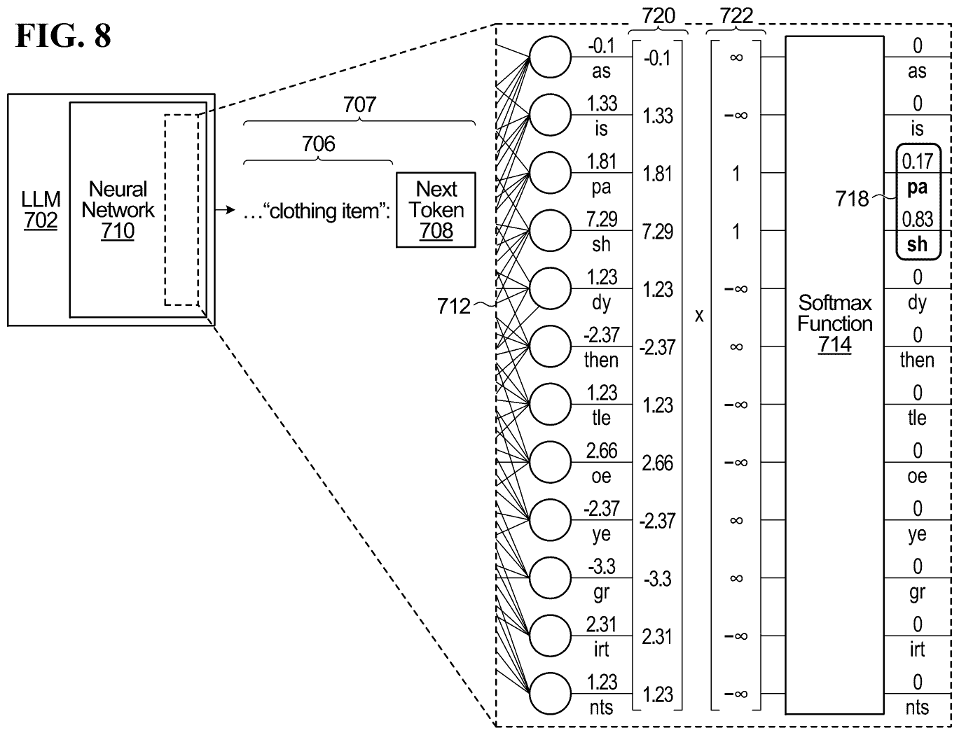

With reference to FIG. 7, sequence of tokens 706 generated by LLM 702 may be used to generate categories 618 classifying input 512, such as image 512b, within taxonomy 616a. Sequence of tokens 706 may be subject to post-processing to generate categories 618, as described above.

As noted previously, a token generated by an LLM is an example of a symbol. A sequence of more than one tokens may also be an example of a symbol. As another example, a numerical representation of one or more characters or segments of text, such as American standard code for information interchange (ASCII) or Unicode is an example of a symbol. A unit of output of an LLM either before or after post-processing is an example of a symbol. Thus, sequence of tokens 706 may form part of a sequence of symbols 707 output by LLM 702, and categories 618 may be based on the sequence of symbols 707. It will be appreciated that sequence of symbols 707 may conform with grammar 616, which may itself define valid sequence of symbols indicating classifications or categories for category 514.

FIG. 7 illustrates an example of generative language model 508 generating a sequence of tokens. The generative language model is implemented as an LLM 702. The LLM 702 may have the example LLM structure described earlier in relation to FIG. 1B, or it may have another structure, e.g. it may only implement a decoder or an encoder, rather than both. The exact structure of the LLM 702 is implementation specific, although in the example of FIG. 7 it is assumed that the LLM 702 has at least one neural network. For ease of explanation, the example illustrated in relation to FIG. 7 will assume that LLM 702 is the generative language model introduced above that can only generate the following tokens: as is pa sh dy then tle oe ye gr irt nts. As mentioned above, this is a simplified example for ease of explanation. In actuality, the LLM 702 may generate thousands of different tokens or more.

LLM 702 receives input 512 and in response generates a sequence of tokens 706. In generating sequence of tokens 706, LLM 702 needs to generate a next token 708 given one or more preceding tokens already generated. In the illustrated example, LLM 702 has already generated a sequence with the immediately preceding tokens being “clothing item”. LLM 702 determines what is the next token 708 given one or more preceding tokens, e.g. given “clothing item”. LLM 702 includes one or more neural networks, although only one is illustrated as neural network 710. As shown in stippled box 712, neural network 710 includes a layer in which there is a respective node corresponding to each possible next token that may be output by LLM 702. The output from each node is indicative of a probability of the respective token being the next token 708. The value output from each node may be a number representing an unnormalized probability, as is the case in the illustrated example. The value output from each node may be a log it value. The plurality of values output from the layer of nodes may be or form a tensor, e.g. a tensor of log it values. In the example, a smaller number means a lower probability that the token is a next token. For example, the node corresponding to the token “gr” outputs the number −3.3, meaning a low probability that “gr” is the next token, whereas the node corresponding to the token “sh” outputs the number 7.29, meaning a high probability that “sh” is the next token. In the illustrated example, the output of the layer is input into a softmax function 714 that maps/scales the numbers into a probability between 0 and 1. Next token 708 is selected as one of the tokens typically having a high or highest probability of being the next token. The illustrated example assumes the grammar 616 introduced earlier. Note that there are tokens that may be selected as the next token 708 that would result in a sequence that is not compliant with the grammar 616. For example, the token “oe” also has a relatively high probability of being the next token (probability of 0.11 in the example), but the sequence “clothing item”: “oe” would not be compliant with grammar 616. That is, “clothing item”: “oe” is not a valid sequence defined by grammar 616. In this example, the only tokens that are valid next tokens in terms of maintaining a grammar-compliant sequence are “pa” and “sh”, as shown at 718.

The generative language model (illustrated as LLM 702 in the example of FIG. 7) may be modified to always generate a next token that is grammar-compliant. In one example, the generative language model generates a plurality of values, each of the values indicative of a probability of a respective token being a next token. A mask is then applied to the plurality of values in the generative language model. The mask operates on each value that corresponds to a token not compliant with the grammar to reduce or zero the probability of that token being the next token. The next token is then determined based on the plurality of values after the mask is applied. As a result, the generative language model will only output a next token that maintains the grammar compliance of the sequence being generated. This process repeats for each next token in the sequence, with the mask being updated based on the grammar for generation of each next token.

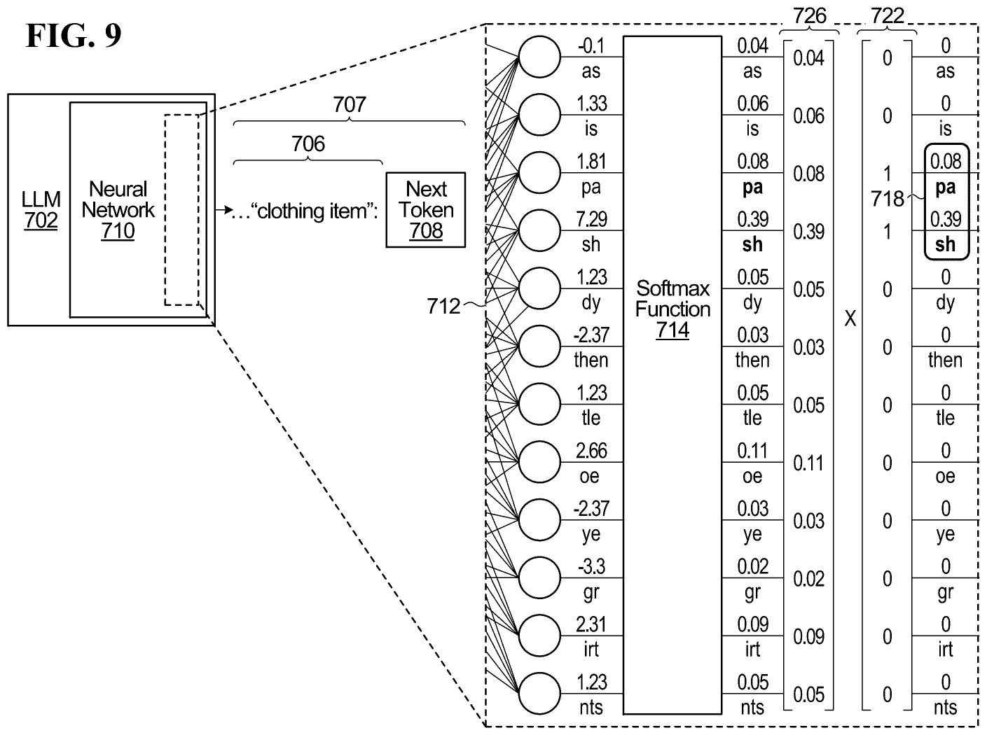

One example of applying the mask is illustrated in FIG. 8, using the example introduced in FIG. 7. The layer of neural network 710 having the plurality of nodes corresponding to each possible token being a next token outputs a tensor 720. The plurality of values in tensor 720 are the unnormalized probabilities referred to above in FIG. 7 and may be log it values. Tensor 720 may be a 1-D tensor or a vector, as is the case in the illustrated example. Prior to softmax function 714, a mask 722 in the form of a second tensor 722 is applied to tensor 720 by performing a tensor product. The application of mask 722 may be considered an additional or final layer in the neural network 710 prior to softmax function 714. For example, application of mask 722 may be a transformation (e.g. GPU-based transformation) as a final layer of LLM 702. Mask 722 includes the identity element at each position in tensor 722 that corresponds to a valid next token. At each position in tensor 722 that corresponds to an invalid next token (in terms of conforming to grammar 616), there is a masking value that in this example is a number of a very large magnitude (shown as infinity) and appropriate sign to make the corresponding value in first tensor 720 very small so that it effectively has an unnormalized probability of never being selected as the next token. The output of the tensor product (i.e. the output after applying mask 722) is input into softmax function 714, which generates a non-zero probability for selection of each possible valid next token, and otherwise maps the other values to a probability of zero (or effectively zero, e.g. a probability so close to zero it would effectively never be selected in operation). LLM 702 will therefore only select “pa” or “sh” as next token 708, which are the only two possible outputs that maintain the grammar compliance of the sequence.

A variation of FIG. 8 is illustrated in FIG. 9 in which mask 722 is instead applied to the output of softmax function 714. In the example of FIG. 9, mask 722 is applied to a vector 726 output by softmax function 714 to zero out each position in the vector 726 corresponding to a token that will not maintain a grammar-compliant sequence. Mask 722 is a vector that has an identity element at each position corresponding to a valid token and has a zero at each other position, and the masking is applied by vector multiplication of vector 728 and mask 722. LLM 702 will therefore only select “pa” or “sh” as next token 708, which are the only two possible outputs that maintain the grammar compliance of the sequence.

In a further example (not depicted), mask 722 may be a logical operation applied to some intermediate output or the output of LLM 702.

Note that how the mask 722 is applied is not limited to the examples in FIGS. 8 and 9. As an example, applying the mask may not literally be implemented by multiplication. Instead, for example, the mask may be an operation of directly or indirectly modifying the values that correspond to tokens that are not grammar-compliant next tokens to reduce or zero their probability of being selected as the next token. The mask may be an operation that strips out or nulls the values (e.g. in the tensor or output from the softmax function) that correspond to tokens that are not grammar-compliant next tokens to reduce or zero their probability of being selected as the next token. The mask may be an instruction or operation to modify or remove the values (e.g. in the tensor or output from the softmax function) that correspond to tokens that are not grammar-compliant next tokens to reduce or zero their probability of being selected as the next token.

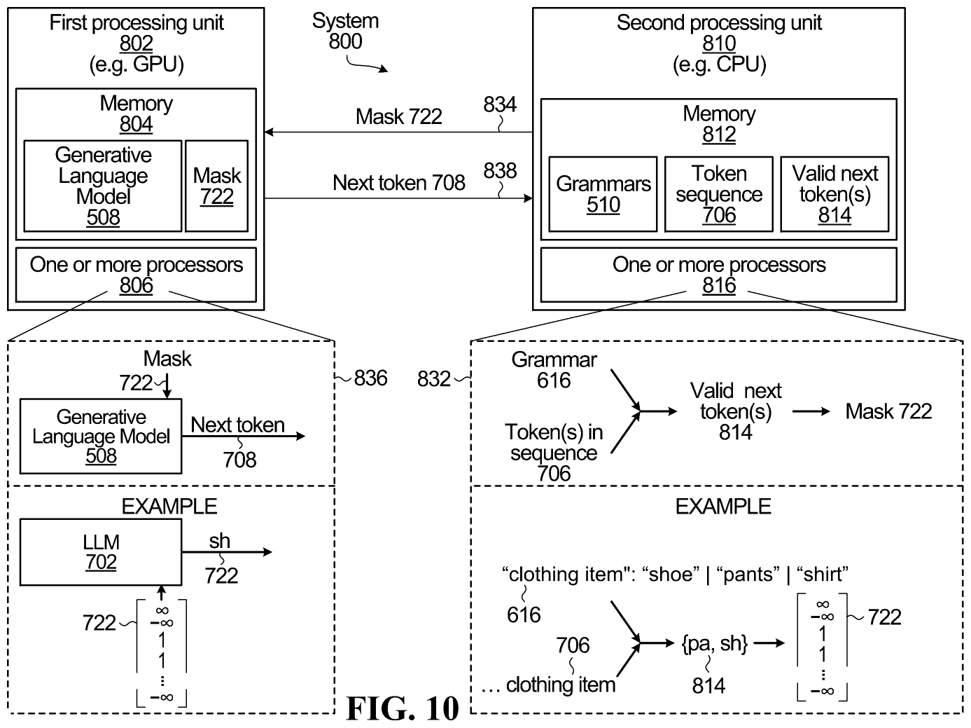

In some examples, system 500 may be implemented as depicted in FIG. 10, which illustrates an example system 800. As noted previously, system 500 includes generative language model 508. In the examples described in FIGS. 7-9, generative language model 508 may be implemented as LLM 702.

As depicted in system 800, generative language model 508 may be implemented using a first processing unit 802. It will be appreciated that in some other implementations, generative language model 508 (e.g. the LLM) may be implemented using another processing unit. First processing unit 802 may be a specialized processing unit designed to accelerate computer operations, e.g. through parallelization of operations, which may allow for faster execution of the generative language model compared to a more general-purpose processing unit. For example, first processing unit 802 may be a graphics processing unit (GPU) or a tensor processing unit (TPU) or a neural processing unit (NPU) or a hardware accelerator. First processing unit 802 may be specialized to perform certain mathematical operations more quickly than general purpose processors, e.g. first processing unit 802 may be able to more quickly implement tensor products and other related computational operations performed by neural networks. First processing unit 802 may include a memory 804 that stores information and computations performed by first processing unit 802. Memory 804 stores generative language model 508, which is illustrated in stippled box 836 as LLM 702 to continue the example introduced earlier. However, generative language model 508 need not be an LLM, let alone the specific example LLM 702 described herein. By “storing” generative language 508, it is meant that the parameters and other values that make up the model and that are required for execution of the model are stored. The parameters depend upon how generative language model 508 is implemented. For example, assuming generative language model 508 utilizes one or more neural networks, the weights and biases of the one or more neural networks are stored. Memory 804 further stores mask 722 to be applied in the generative language model for generation of the next token 708. First processing unit 802 further includes one or more processors 806, which perform the operations of first processing unit 802. For example, the one or more processors 806 execute LLM 702 and apply mask 722 to generate a grammar-compliant sequence of tokens in the manner explained herein. The one or more processors 806 may each be implemented as a processor that executes instructions stored in memory, or it/they may be or include dedicated integrated circuits, such as one or more field programmable gate arrays (FPGAs) and/or one or more application-specific integrated circuits (ASICs). The one or more processors 806 may be or include one or more processing cores. The one or more processors 806 may be or include one or more processing cores on a GPU.

System 800 further includes a different second processing unit 810. First processing unit 802 and second processing unit 810 may communicate with each other, e.g. over a network or bus (not illustrated), to send information to each other. In one example, second processing unit 810 may send API requests (“API calls”) to first processing unit 802 to send information to (e.g. send the mask 722 to) and receive information from (e.g. receive the next token 708 from) the first processing unit 802.

Second processing unit 810 may be a general-purpose processing unit that is not specialized, e.g. it may be a central processing unit (CPU) of a server or other computer. Second processing unit 810 might not directly execute intensive specialized computations like machine learning models, but may utilize such specialized electronic circuits, e.g. through API calls. For example, second processing unit 810 may be the server or other computer serving a user. If the user makes a request that requires generation of a program code, then second processing unit 810 may communicate with first processing unit 802 to instruct first processing unit 802 to execute LLM 702 to describe input 512. Second processing unit 810 includes a memory 812 for storing information, values, and instructions needed and/or used by second processing unit 810. In this example, second processing unit 810 stores in memory 812 an indication of grammars 510, which may obtain a grammar to be used by LLM 702, such as by retrieving or generating a grammar. Grammars 510 may be used to obtain grammar 616 introduced earlier, but of course any other grammar may be obtained by grammars 510. Grammar 616 is just used as an example for ease of explanation. Memory 812 also stores sequence of tokens 706 returned from the LLM 702, where sequence of tokens 706 are classifications or categories for input 512 generated by LLM 702. In the example of FIG. 10, second processing unit 810 has knowledge of grammar 616 and therefore generates mask 722 to be applied by LLM 702 for each token generation iteration of LLM 702. To generate mask 722, second processing unit 810 needs to determine the valid set of next token(s) 814 given grammar 616 and token sequence 706 already generated by LLM 702. The valid set of next token(s) 814 is stored in memory 812.

Second processing unit 810 further includes one or more processors 816, which perform the operations of the second processing unit 810. For example, one or more processors 816 receive the already generated token sequence from LLM 702, generate mask 722 based on one or more previously generated tokens of the token sequence, and transmit mask 722 back to first processing unit 802 for use by LLM 702 to generate next token 708 in the sequence. One or more processors 816 may each be implemented as a processor that executes instructions stored in memory, or they may be or include dedicated integrated circuits, such as one or more GPUs, FPGAs, and/or ASICs. One or more processors 816 may be or include one or more processing cores. One or more processors 816 may be or include one or more processing cores of a CPU.

FIG. 10 also illustrates operations performed by the one or more processors of each processing unit. As illustrated in stippled box 832, one ore more processors 816 of second processing unit 810 generate a set of valid next tokens 814 based on grammar 616 and token sequence 706 already generated by LLM 702, e.g. based on one or more preceding tokens in the token sequence. For example, if the token sequence already generated is “clothing item”, then according to the grammar 616, a grammar-compliant symbol is “shoe”, “pants” or “shirt”, which means that the next valid tokens include “pa” and “sh”. These two tokens make up the set of valid next tokens 814. One or more processors 816 then generate mask 722 based on the set of valid next tokens 814, e.g. by including an identity element in each position in the mask that corresponds to a valid next token, and otherwise putting a masking value in the other positions to act on the values in LLM 702 that correspond to the other tokens. An example is also illustrated in stippled box 832 in which the rules of the grammar 616 and the immediately preceding tokens in the sequence “clothing item”, are used to generate a set of valid tokens 814 {pa, bsh}, which are used to generate mask 722 illustrated in FIG. 8. Mask 722 is then transmitted to first processing unit 802, as shown at 834.

Turning now to stippled box 836, LLM 702 then takes mask 722 and applies it during the generation of next token 708, such that LLM 702 will only generate a next token that maintains the grammar-compliance of the token sequence 706. An example is illustrated in stippled box 836 in which mask 722 from FIG. 8 is applied via a tensor product (as discussed in relation to FIG. 8), after which LLM 702 generates a next token 708, which in the example is the token “sh”. Next token 508 is then transmitted to second processing unit 810, as shown at 838. Second processing unit 810 then updates stored token sequence 706 to append that next token 708 and then uses the updated token sequence 706 and grammar 616 to generate a new set of valid next token(s) 814, to generate a new mask 722. For example, given that the token sequence is now . . . “clothing item”: “sh”, according to the grammar the only valid next tokens are “oe” and “irt”, and so the updated mask 722 would act to cause the values not corresponding to “oe” and “irt” to have zero probability (or close to zero probability) of being selected. The updated mask 722 is then transmitted to first processing unit 802 for use by the LLM 702 to generate the next token, and the process continues in this way until LLM 702 reaches a stop condition and ends the token sequence, at which point token sequence 706 is grammar-compliant and describes input 512. In some embodiments, the LLM 702 stop condition may be controlled to ensure that LLM 702 does not stop in the middle of a grammar rule, but rather stops at a point where categories 618 classifying input 512 are valid. One example way to achieve this may be to tie the stop condition to generation of a terminal symbol that, according to the grammar, is associated with an end of categories 618 classifying input 512.

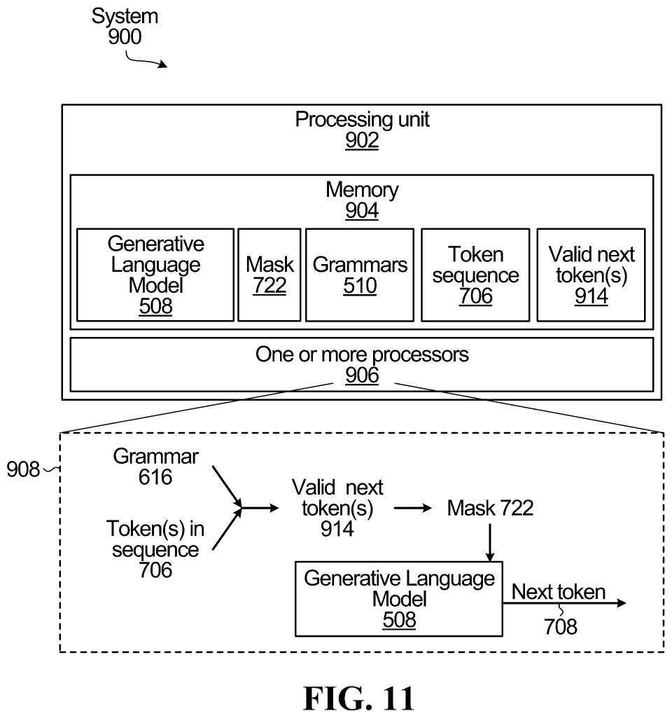

The use of two separate processing units by system 800 depicted in FIG. 10 is only one example implementation. In general, there may be one or multiple processing units that may work together. For example, a system 900 is depicted in FIG. 11. System 900 depicted in FIG. 11 is the same as system 800 depicted in FIG. 10 except that everything is performed on a single processing unit 902, e.g. on a single server or other computer. The relevant information is stored in single memory 904 (which may be distributed), and a single set of one or more processors 906 performs the operations, e.g. the operations shown in stippled box 908 in which the grammar 616 and token(s) in the already generated sequence 706 are used to determine the set of valid next token(s) 914, which is then used to generate a mask 722, which is then applied to generation of the next token 708 in the generative language model 508 (which, in some implementations, may be LLM 702). In this example, there is not necessarily a specialized processing circuit (e.g. GPU) to implement generative language model 508, but instead all operations are performed by a same processing unit, which might be a general purpose processor.

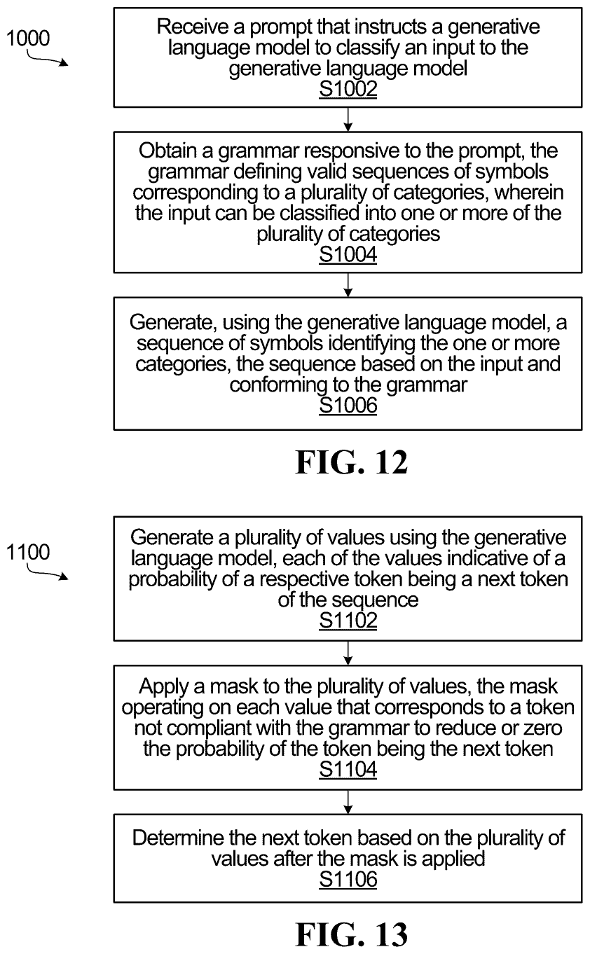

FIG. 12 illustrates a computer-implemented method 1000, according to one implementation. Method 1000 may be performed by at least one processing unit, which might or might not be distributed. For example, the at least one processing unit may be one or more processors 504, or it may be processing unit 902, or it may be first processing unit 802, or it may be second processing unit 810, or it may be a combination of first processing unit 802 and second processing unit 810 working together like explained in relation to FIG. 10, etc.

At step S1002, a prompt is received that instructs a generative language model to classify an input to the generative language model. The generative language model may be generative language model 508. In some implementations, generative language model may be implemented as an LLM, such as LLM 702 depicted in FIGS. 7-9.

Input may be, for example, input 512. In some examples, input 512 may include an input prompt 512a and image 512b. Prompt may be input prompt 512a. In some further examples, input 512 may include input prompt 512a and some other input element, such as a video or some other form(s) of data. Input 512 may also include multiple types of data.

It will be appreciated that generative language model 508 may multi-modal.

Input, such as input 512, may be rescaled and/or compressed, such as to reduce the memory and computing resources required to transmit and/or process input 512. For example, if the input includes an image, such as image 512b, the rescaling may reduce the resolution of the image. Image 512b may also be converted from color to grayscale.

At step S1004, a grammar is obtained responsive to the prompt. The grammar defines valid sequences of symbols corresponding to a plurality of categories. The input can be classified into one or more of the plurality of categories.

As noted above, prompt may be input prompt 512a. The grammar may be obtained using grammars 510. As well, the grammar may be obtained responsive to input prompt 512a. In some examples, the grammar may be obtained in response or responsive to receiving input prompt 512a at step S1002, without necessarily analyzing the content of input prompt 512a. In these examples, there may be only one possible grammar which may be obtained, such as only one grammar file stored in memory or a database, or only one grammar which may be generated. In other examples, the grammar may be obtained by analyzing the content of input prompt 512a, such as by grammars 510 analyzing input prompt 512a. In these examples, the grammar may be obtained in response or responsive to the content of input prompt 512a.

In some examples, the grammar may be grammar 516 and may be obtained using grammars 510. Obtaining grammar 516 may include retrieving grammar 516 from memory, such as memory 502 depicted in FIG. 3, memory 812 depicted in FIG. 10, memory 904 depicted in FIG. 11, or some other memory or combination of memories. Obtaining grammar 516 may also include dynamically generating grammar 516, as will be described in more detail below. The obtained grammar 516 may be stored or encoded in a grammar file.

Another example of a grammar may be grammar 616, as depicted in FIGS. 5-7. Grammar 616 may be associated with a taxonomy 616a, which may be “clothing item”. Grammar 616 may include grammar rules 616b (“clothing item”: “shoe” | “pants” | “shirt”) defining plurality categories 616c (e.g. “shoe”, “shirt” and “pants”).

The grammar may define valid sequences of symbols corresponding to (e.g. defining, delineating, identifying, etc.) the plurality of categories. In the example of grammar 616, grammar 616 defines valid sequences of symbols “shoe”, “shirt” and “pants”, which define the plurality of categories 616c within the taxonomy 616a for “clothing item”. It will be appreciated that the grammar may define many other valid sequences of symbols and categories.

In some examples, more than one grammar may be obtained at step S1004.

In some implementations, grammars 510 may include instructions for generating one or more grammars, and obtaining the one or more grammars may include one or more processors 504, one or more processors 806, one or more processors 816 or one or more processors 906 executing the instructions to generate the one or more grammars.

In other implementations, grammars 510 may include one or more grammars stored in memory, and obtaining the one or more grammars may include selecting one or more of the grammars of grammars 510.

At step S1006, using the generative language model, a sequence of symbols are generated identifying the one or more categories. The sequence is based on the input and conforms to the grammar. One example of the generative language model be generative language model 508, depicted in FIGS. 5-6. In a further example, the generative language model may be an LLM, such as LLM 702 depicted in FIGS. 7-10.

As explained above, the term “symbols” encompasses tokens, text (such as segments or chunks of text), characters, or numerical representations thereof. For example, a token generated by the generative language model, such as LLM 702, is an example of a symbol. A sequence of more than one token generated by the generative language model, such as LLM 702, may also be an example of a symbol. As another example, a numerical representation of one or more characters or segments of text, such as American standard code for information interchange (ASCII) or Unicode is an example of a symbol. A unit of output of an LLM either before or after post-processing is an example of a symbol.

Identifying the one or more categories may include listing, describing and/or delineating the one or more categories.

The one or more categories may be categories 518. In some examples, the one or more categories may be categories 618. Categories 618 may be based on the sequence of symbols, for example. As noted above, categories 618 may identify categories within which the input has been classified, such as input 512. In a further example, the sequence of symbols may be sequence of symbols 707, and categories 618 may be based on sequence of symbols 707. As depicted in the example of FIG. 5, categories 618 may identify the category “shoe” from plurality of categories 616c for taxonomy 616a. It will be appreciated that sequence of symbols 707 and categories 618 may conform to the grammar, such as grammar 606. In a further example, formatted categories 620 may be based on the sequence of symbols, such as sequence of symbols 707. In this example, formatted categories 620 is generated directly by generative language model 508. By conforming to the grammar, the sequence of symbols, such as sequence of symbols 707, are generated within a predefined format (specified by the grammar).

Sequence of symbols may include programming language code. For example, the grammar may constrain the valid sequences of symbols to a syntax of a programming language, and so formatted categories 620 may include code in the programming language.

In some implementations, where input 512 includes an input prompt 512a, input prompt 512a may instruct generative language model 508, such as LLM 702, to classify input 512. For example, input 512 may include image 512b, and input prompt 512a may instruct generative language model 508 to classify or categorize input image 512b. Generative language model may generate a sequence of symbols, such as sequence of symbols 707, based on input prompt 512a, grammar 616 and input image 512b. In other examples where input 512 include an input prompt and another input element, such as an image, another data type or a combination of data types, generative language model may generate a sequence of symbols, such as sequence of symbols 707, based on the input prompt, grammar 616 and input element (which may include one or more data types).

In some alternate implementations of method 1000, steps S1002 and S1004 may be combined such that a grammar may be obtained regardless of a prompt, i.e. without the needing to receive a prompt. In such examples, the grammar is not obtained responsive to the input, but instead the grammar is predefined, e.g. if a generative language model, such as an LLM, is used to classify the input and the generative language model is dedicated classifying only a single taxonomy (or a plurality of taxonomies) and only enforces a single grammar describing that taxonomy (or plurality of taxonomies).

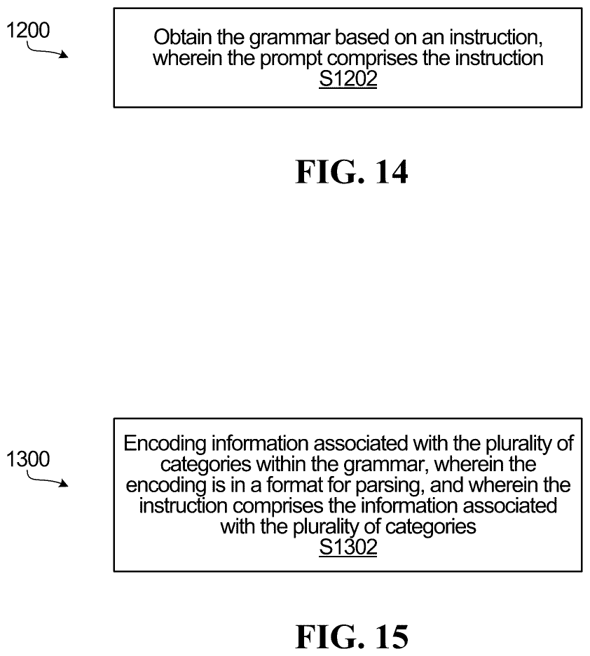

FIG. 13 illustrates a computer-implemented method 1100 for performing step S1006 for generating, using a generative language model, a sequence of symbols identifying the one or more categories, the sequence based on the input and conforming to the grammar, according to one implementation. Method 1100 may be performed by at least one processing unit, which might or might not be distributed. For example, the at least one processing unit may be one or more processors 504, or it may be processing unit 902, or it may be first processing unit 802, or it may be second processing unit 810, or it may be a combination of first processing unit 802 and second processing unit 810 working together like explained in relation to FIG. 10, etc.

At step S1102, a plurality of values are generated using the generative language model. Each of the plurality of values is indicative of a probability of a respective token being a next token in the sequence of symbols.

As noted above, the generative language model may be generative language model 508. In some examples, the generative language model may an LLM, such as LLM 702 depicted in FIGS. 7-10. LLM 702 may include one or more neural networks, although only one is illustrated as neural network 710.

As depicted in the example of FIG. 7, the plurality of values may be generated using the generative language model, such as LLM 702. The plurality of values may indicate a probability of a respective token being a next token, such as next token 708, in the sequence of symbols, such as sequence of symbols 707. In the example depicted in FIG. 7, the plurality of values output from the layer of nodes in LLM 702 may be or form a tensor, e.g. a tensor of log it values. A smaller number in the depicted example means a lower probability that the token is a next token. For example, the node corresponding to the token “gr” outputs the number −3.3, meaning a low probability that “gr” is the next token, whereas the node corresponding to the token “sh” outputs the number 7.29, meaning a high probability that “sh” is the next token. In the example depicted in FIG. 7, the output of the layer is input into a softmax function 714 that maps/scales the numbers into a probability between 0 and 1.

At step S1104, a mask is applied to the plurality of values. The mask operates on each value that corresponds to a token not compliant with the grammar to reduce or zero the probability of the token being the next token.

One example of applying the mask is illustrated in FIG. 8, using LLM 702. In this example, the mask may be mask 722. The layer of neural network 710 having the plurality of nodes corresponding to each possible token being a next token outputs a tensor 720. The plurality of values may be in the form of tensor 720, which includes the unnormalized probability of a respective token being a next token in the sequence of symbols. Mask 722 may be in the form of a second tensor 722, which may be applied to tensor 720 by performing a tensor product.

In another example, mask 722 may be applied at the output of softmax function 714, as depicted in FIG. 9. Mask 722 may be a vector that has an identity element at each position corresponding to a valid token and has a zero at each other position, and the masking may be applied by vector multiplication of vector 726 and mask 722.

At step S1106, the next token is determined based on the plurality of values after the mask is applied. Note that there are tokens that may be selected as the next token 708 that would result in a sequence that is not compliant with the grammar 616. For example, the token “oe” depicted in FIGS. 7-9 also has a relatively high probability of being the next token (probability of 0.11 in the example), but the sequence “clothing item”: “oe” would not be compliant with grammar 616. That is, “clothing item”: “oe” is not a valid sequence defined by grammar 616. In this example, the only tokens that are valid next tokens in terms of maintaining a grammar-compliant sequence are “pa” and “sh”, as shown at 718.

In the example depicted in FIG. 8, the application of mask 722 may be a transformation as a final layer of LLM 702. Mask 722 may include the identity element at each position in tensor 722 that corresponds to a valid next token. At each position in tensor 722 that corresponds to an invalid next token (in terms of conforming to grammar 616), there may be a masking value that in this example is a number of a very large magnitude (shown as infinity) and appropriate sign to make the corresponding value in first tensor 720 very small so that it effectively has an unnormalized probability of never being selected as the next token. The output of the tensor product (i.e. the output after applying mask 722) is input into softmax function 714, which generates a non-zero probability for selection of each possible valid next token, and otherwise maps the other values to a probability of zero (or effectively zero, e.g. a probability so close to zero it would effectively never be selected in operation). In the example depicted in FIG. 8, LLM 702 will therefore only select “pa” or “sh” as next token 708, which are the only two possible outputs that maintain the grammar compliance of the sequence. Note that in the example of FIG. 8 where the masking value needs to have the appropriate sign (+ or −), in some implementations the sign might not be generated as part of the mask 722 because it might not be known in advance (when the mask 722 is generated) which values are going to be negative numbers versus positive numbers. In this situation, the mask might just have magnitude “infinity” (very large number) in each position corresponding to a token that is not a valid next token, and the generative language model applies the appropriate sign when performing the tensor product.

In the example depicted in FIG. 9, mask 722 may be applied at the output of softmax function 714. Mask 722 may be applied to zero out each position in the vector 726 corresponding to a token that will not maintain a grammar-compliant sequence. Since mask 722 in this example may be a vector that has an identity element at each position corresponding to a valid token and has a zero at each other position, the masking may be applied by vector multiplication of vector 726 and mask 722. LLM 702 may therefore only select “pa” or “sh” as next token 708, which are the only two possible outputs that maintain the grammar compliance of the sequence.

FIG. 14 illustrates a computer-implemented method 1200 for performing step S1004 for generating, using obtaining a grammar responsive to the prompt, the grammar defining valid sequences of symbols corresponding to a plurality of categories, wherein the input can be classified into one or more of the plurality of categories, according to one implementation. Method 1200 may be performed by at least one processing unit, which might or might not be distributed. For example, the at least one processing unit may be one or more processors 504, or it may be processing unit 902, or it may be first processing unit 802, or it may be second processing unit 810, or it may be a combination of first processing unit 802 and second processing unit 810 working together like explained in relation to FIG. 10, etc.

At step S1202, the grammar is obtained based on an instruction, wherein the prompt includes the instruction. Input 512 may include the instruction. For example, input 512 may include input prompt 512a, which may include the instruction. The instruction may instruct the generative language model, such as generative language model 508, to classify input 512. For example, if input 512 also includes some other input element, such as image 512b, the instruction within input prompt 512a may instruct generative language model 508 to classify image 512b. In some examples, the instruction may also instruct generative language model 508 to classify input 512, such as image 512b, within a certain taxonomy. In some examples, the instruction may only identify the name of the taxonomy, such as taxonomy 616a (e.g. “clothing item”). In further examples, the instruction may also identify a plurality of categories within the taxonomy, such as plurality of categories 616c (e.g. “shoe”, “pants” and “shirt”). In even further examples, the instruction may also or instead identify grammar rules for the taxonomy, such as grammar rules 616b, which may be used to obtain a grammar, such as grammar 616, and/or be ingested by the generative language model.

In some examples, one or more grammars may be obtained at step S1202, and generative language model may classify the input using one or more grammars instead of just a single grammar.

In some implementations, the instruction may in addition or instead instruct system 500 (or system 800, system 900, some other system, or some combination of these systems) to retrieve the grammar, such as from memory or from a database. The instruction may also include instructions for looking up the grammar in memory or in the database. The memory may be identified as memory 502, memory 804, memory 812, memory 904 or some other memory. The grammar may be contained within a grammar file, saved in memory or a database. The instruction may identify whether a taxonomy name identified in the instruction should be used to look up the grammar, such as grammar 616, and whether an exact match or a partial match between the taxonomy identified in the instruction and the taxonomy in the grammar, such as taxonomy 616a, is required. The instruction may also identify whether other information should be used to retrieve grammar 616.

In some examples, grammar 616 may be stored in grammars 510, which may include one or more grammars stored in memory, such as memory 502 depicted in FIG. 3, memory 812 depicted in FIG. 10, memory 904 depicted in FIG. 11, or some other memory or combination of memories.

In some further examples, grammars 510 may include a database (not shown). The category associated with the grammar, such as grammar 616, may be stored in the database. As well, other categories may also be stored in the database. The database may be queried with some or all of input prompt 512a, such as some or all of the instruction within input prompt 512a to determine that retrieve grammar 616. In some examples, the database may be queried with taxonomy 616a or a portion or all of plurality of categories 616c to retrieve grammar 616 that matches taxonomy 616a or plurality of categories 616c.

In other implementation, the instruction may in addition or instead instruct system 500 (or system 800, system 900, some other system, or some combination of these systems) to generate the grammar, such as grammar 616. Grammar 616 may be generated dynamically. The instruction may provide instructions for generating the grammar, such as identifying contents that should be stored or encoded within grammar 616. The contents may include taxonomy 616a and grammar rules 616b. Alternatively or in addition, the contents may include taxonomy 616a and plurality of categories 616c. It will be appreciated that grammar rules 616b may be generated based on plurality of categories 616c. The instructions may also provide instructions for encoding grammar, such as grammar rules 616b, within a grammar file. The instructions may provide the syntax for encoding grammar 616 within the grammar file, such as whether a mark-up language, programming language or other format for parsing should be used.

In some examples, grammars 510 may include instructions for generating one or more grammars, including grammar 616, and one or more processors 504 may execute the instructions to generate the one or more grammars.

FIG. 15 illustrates a computer-implemented method 1300 for performing step S1202 for obtaining the grammar based on an instruction, wherein the prompt includes the instruction, according to one implementation. Method 1300 may be performed by at least one processing unit, which might or might not be distributed. For example, the at least one processing unit may be one or more processors 504, or it may be processing unit 902, or it may be first processing unit 802, or it may be second processing unit 810, or it may be a combination of first processing unit 802 and second processing unit 810 working together like explained in relation to FIG. 10, etc.

At step S1302, information associated with the plurality of categories is encoded within the grammar. The encoding may be in a format for parsing. The instruction includes the information associated with the plurality of categories.

As noted above, the instruction instructs system 500 (or system 800, system 900, some other system, or some combination of these systems) to generate the grammar, such as grammar 616. Grammar 616 may be generated dynamically, such as by grammars 510. The instruction may provide instructions for generating the grammar, such as identifying information associated with plurality of categories 616c that should be stored or encoded within grammar 616. It will be appreciated that grammar rules 616b may be generated based on plurality of categories 616c. The information associated with the plurality of categories 616c may also include taxonomy 616a. In some examples, the information associated with the plurality of categories 616c may also include grammar rules 616b in addition to plurality of categories 616c. In other examples, the information associated with the plurality of categories 616c may also include grammar rules 616b instead of categories 616c.

The information associated with the plurality of categories may also provide instructions for encoding grammar, such as grammar rules 616b, within a grammar file. The instructions may provide the syntax for encoding grammar 616 within the grammar file, such as whether a mark-up language, programming language or other format for parsing should be used. As depicted in FIGS. 5-6, grammar 616 may be stored or encoded in the JSON mark-up language or syntax. It will be appreciated that the grammar file may be in the format for parsing, i.e. in the syntax of the mark-up language or programming language.

In some implementations, grammars 510 may include instructions for generating one or more grammar, and obtaining the one or more grammars may include one or more processors 504, one or more processors 806, one or more processors 816 or one or more processors 906 executing the instructions to generate the one or more grammars.

FIG. 16 illustrates another computer-implemented method 1400 for performing step S1202 for obtaining the grammar based on an instruction, wherein the prompt includes the instruction, according to one implementation. Method 1400 may be performed by at least one processing unit, which might or might not be distributed. For example, the at least one processing unit may be one or more processors 504, or it may be processing unit 902, or it may be first processing unit 802, or it may be second processing unit 810, or it may be a combination of first processing unit 802 and second processing unit 810 working together like explained in relation to FIG. 10, etc.

At step S1402, it is determined that the instruction is associated with a label representative of the plurality of categories to which the grammar relates, wherein the grammar further includes the label.

The grammar may be grammar 516. In one example, the grammar may be grammar 616. The label may be taxonomy 616a of grammar 616. The label may also be or instead include some or all of plurality of categories 616c of grammar 616, such that grammar 616 can be identified or retrieved based on its categories as well or in addition to the taxonomy name.

In some implementations, the label may be the name of a grammar file stored in memory. The file may be named after taxonomy 616a (e.g. “clothing item”) or may be name in part after taxonomy 616a (e.g. “taxonomy: clothing item”). The file may also be named after one or more of the plurality of categories 616c (e.g. “shoe−pants−shirt”). The file may also be named after the taxonomy 616a and one or more of the plurality of categories (e.g. “taxonomy: clothing item=shoe−pants−shirt”). In other implementations, the label may be metadata associated with the grammar file. The label may also be a file path name, folder name, or other data representative of the plurality of categories to which the grammar relates.

In further implementations, the label may be a field stored in a database in relation to the grammar, such as in relation to grammar rules 616b or a grammar file containing the grammar.

Determining that the instruction is associated with the label may include matching the instruction or some aspect of the instruction, as discussed above in method 1200, with the label or some aspect of the label. In some implementations, this may include matching the name of the grammar file, metadata for the grammar field, the name of the folder containing the grammar file and/or the file path pointing to the grammar file against the instruction. In some implementations, this may include querying a database using the instruction or some aspect of the instruction and matching the instruction against a field in the database related to the grammar.

In some examples, the instruction may not exactly match the label. For example, grammar 616 may be associated with the label “clothing item” but the instruction may be “items of clothing”. In this example, it may still be determined that the instruction is associated with the label.

At step S1404, the grammar is selected from a set of one or more grammars. Selecting the grammar may include retrieving a grammar file from memory or from a database, downloading a grammar file, copying a grammar file, loading a grammar and/or grammar rules.

In some examples, more than one grammar may be selected. The grammars may include grammar 616. In other examples, only one grammar, such as grammar 616, may be selected.

Grammar 616 may be selected from the set of one or more grammars included in grammars 510. Selecting grammar 616 may include selecting a grammar file associated with grammar 616, e.g. a grammar file containing grammar 616,

In the example where grammars 510 includes one or more grammars stored in memory, grammar 616 may be selected from memory. Grammar 616 may be identified because, as indicated in step S1402, label is representative of the plurality of categories to which the grammar relates, e.g. category plurality of categories 616c and/or taxonomy 616a are associated with grammar 616 in memory.

In the example where grammars 510 includes a database, grammar 616 may be stored in the database in associated with the label. Alternatively or in addition, grammar rules 616b may be stored in the database in association with the label. It will be appreciated that grammar 616 (and/or grammar rules 616b) and other grammars (and/or other grammar rules) may each be stored in relation to one or more labels in the database as well. Grammar 616 may be selected from database after querying database in step S1402. One or more other grammars may also be selected from database after querying the database in step S1402.

In some implementations, one or more grammars, such as grammar 616, may be downloaded from a server. The one or more grammars may be downloaded as one or more grammar files. In these implementations, grammars 510 may only be accessible over a network, such as a local network or the Internet. Grammars 510 may be a data server, a website, a database, an API or some other entity accessible over a network. Alternatively, grammars 510 may download grammar 616 from a separate data server, website, database over a network or through an API.

FIG. 17 illustrates another computer-implemented method 1500 for performing step S1202 for obtaining the grammar based on an instruction, wherein the prompt includes the instruction, according to one implementation. Method 1500 may be performed by at least one processing unit, which might or might not be distributed. For example, the at least one processing unit may be one or more processors 504, or it may be processing unit 902, or it may be first processing unit 802, or it may be second processing unit 810, or it may be a combination of first processing unit 802 and second processing unit 810 working together like explained in relation to FIG. 10, etc.

At step S1502, information associated with the plurality of categories is retrieved from a memory, wherein the memory includes the information associated with the plurality of categories.

Information associated with the plurality of categories (e.g. plurality of categories 616c) may include grammar rules, such as grammar rules 616b. The information may also include taxonomy 616a. In some examples, the information associated with the plurality of categories, such as plurality of categories 616c, may be identified based on an association between taxonomy 616a and the information associated with the plurality of categories 616c in memory.

In some further examples, the information associated with the plurality of categories 616c may not include grammar rules 616b, and may instead only include some indication of plurality of categories 616c.

Grammars 510 may be used to retrieve the information associated with the plurality of categories, such as plurality of categories 616c, from memory. The memory may be memory 502, memory 804, memory 812, memory 904 or some other memory.

At step S1504, the information with the plurality of categories is encoded within the grammar, wherein the encoding may be in a format for parsing.

In the examples where the information associated with the plurality of categories 616c includes grammar rules 616b, grammars 510 may encode grammar rules 616b in grammar 616, such as in a grammar file, in a format for parsing.

In the examples where the information associated with the plurality of categories 616c does not include grammar rules 616b and only includes some indication of plurality of categories 616c, grammars 510 may encode plurality of categories 616c into grammar by first converting plurality of categories 616c into grammar rules 616b. Grammar rules 616b may then be stored or encoded in grammar 616, such as in a grammar file, in a format for parsing.

Taxonomy 616a may also be stored or encoded within grammar 616, such as within the grammar file. The grammar file may also be named after taxonomy 616a or associated with taxonomy 616a or plurality of categories 616c in memory.

The format for parsing may be a mark-up language, such as JSON, or a programming language.

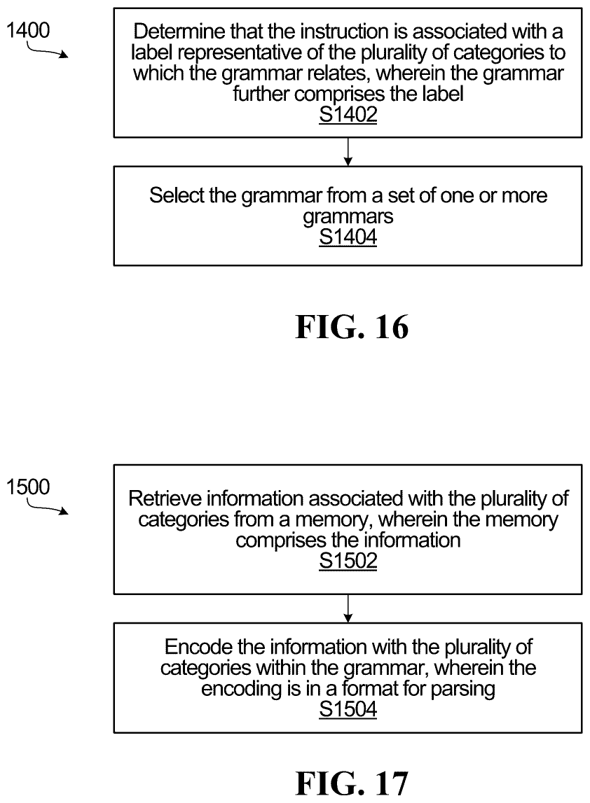

FIG. 18 illustrates a further computer-implemented method 1600 for modifying a grammar. Method 1600 may be performed by at least one processing unit, which might or might not be distributed. For example, the at least one processing unit may be one or more processors 504, or it may be processing unit 902, or it may be first processing unit 802, or it may be second processing unit 810, or it may be a combination of first processing unit 802 and second processing unit 810 working together like explained in relation to FIG. 10, etc.

It will be appreciated that unlike typical classifiers, the grammar-constrained classifier depicted in FIG. 3 may be reconfigured to classify an updated taxonomy without retraining or fine-tuning of the model itself. Conversely, a typical classifier may need to be retrained on an updated data set, which consumes computer and/or networking resources. The grammar-constrained classifier depicted in FIG. 3 may thus be used to reduce the consumption of computing resources, as well as improve computing speed and efficiency. For example, if a new category is added to the classifier taxonomy, such as taxonomy 616a, only grammar 616 needs to be updated. Generative language model 508 may not need to be re-trained or altered. Once that is complete, generative language model 508 may be able to classify input, such as input 512, using the updated grammar 616.

At step S1602, an update to the plurality of categories is received. In the example of grammar 616, the plurality of categories may be plurality of categories 616c, such as “shoe”, “pants” and “shirt” for the taxonomy 616a “clothing item”. The update may include an addition, deletion, amendment or other modification to plurality of categories 616c. In some examples, the update may be the addition of a new category “jacket”. In other examples, the update may be the deletion of the category “pants”. In further examples, the update may be the amendment to modify the category “shirt” to be “dress shirt”, or to replace the category “shirt” with the category “dress shirt”. In some further examples, the update may include multiple updates, such as one or more additions, deletions and/or amendments.

Grammars 510 may be configured to receive the update to plurality of categories 616c.

At step S1604, the valid sequences of symbols in the grammar may be modified based on the update to the plurality of categories. The valid sequences of symbols may be specified in one or more grammar rules. In the example of grammar 616, the one or more grammar rules may be grammar rules 616b.

In the example where the update is an addition of a new category “jacket”, grammar rules 616b may be modified to be “clothing item”: “shoe” | “pants” | “shirt” | “jacket”.

In the example where the update is a deletion of the category “pants”, the grammar rules 616b may be modified to be “clothing item”: “shoe” | “shirt”.

In the example where the update is an amendment to modify the category “shirt” to be “dress shirt”, grammar rules 616b may be modified to be “clothing item”: “shoe” | “pants” | “dress shirt”.

Grammars 510 may be configured to modify the grammar, such as grammar 616. In some examples, grammars 510 may modify grammar 616 stored in memory. In other examples, grammars 510 may modify grammar 616 stored in a database. In some of these examples, grammars 510 may modify a grammar file containing grammar rules 616b.

In some further implementations, plurality of categories 616c may stored in memory, in a database or over a network. Grammars 510 may modify plurality of categories 616c instead of grammar rules 616b. In these implementations, grammars 510 may be configured to dynamically generate grammar 616 and/or a grammar file from plurality of categories 616c, such that only plurality of categories 616c need to be modified with the update for grammar-constrained generative language model to be capable of classifying with the updated taxonomy.

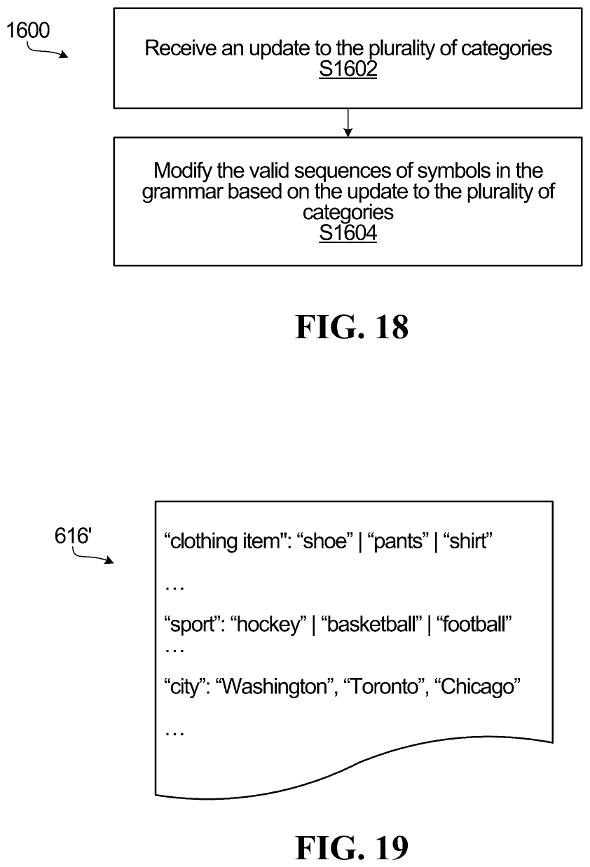

FIG. 19 depicts a grammar 616′ according to another implementation. In this implementation, grammar 616′ includes a plurality of taxonomies, such as “clothing item”, “sport” and “city”. Each of the plurality of taxonomies includes a plurality of categories incorporated into one or more grammar rules.

It will be appreciated that grammar 616′ may be used by generative language model 508 to classify a variety of inputs into one or more categories. For example, an input may include an image of a basketball and be accompanied by an input prompt asking the generative language model 508 to classify the image into a type of sport. System 500 may retrieve grammar 616′ responsive to the input prompt, such as based on the word “sport”. Grammar 616′, for example, may be associated with a plurality of taxonomies (e.g. “clothing item”, “sport” and “city”) in memory, in metadata, in a database, etc., such that grammars 510 may retrieve grammar 616′ response to the input. Grammar 616′ may be retrieved using the methods 1200, 1300, 1400 and 1500 described above.

Grammar 616′ may be used to constrain the output of generative language model 508 to classify the input using the methods 1000 and 1100 described above. Generative language model 508 may accurately classify the input as “sport”: “basketball” using grammar 616′.

It will be appreciated that the same process and the same grammar 616′ may be used to classify an image of a shoe, such as image 512b for input 512 depicted in FIGS. 5-6.

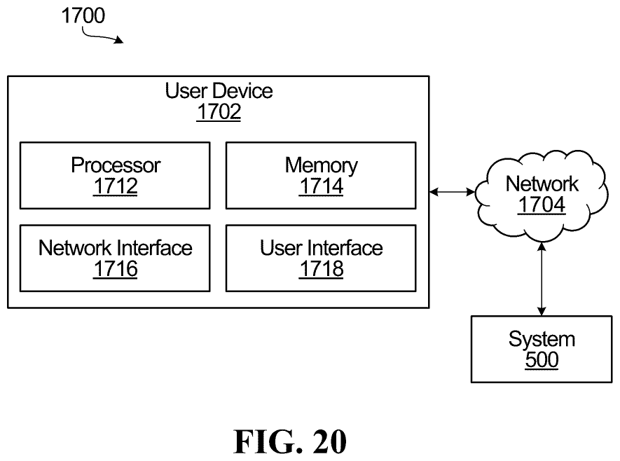

FIG. 20 depicts a computing system 1700, which allows a user device 1702 to communicate with system 500 over a network 1704. In other implementations, system 500 may instead be system 800 depicted in FIG. 10 or system 900 depicted in FIG. 11. It will be appreciated that in further implementations, system 1700 may allow user device 1702 to communicate with more than one system, such as a combination of system 500, system 800, system 900, and/or multiple instances of any of these systems.

User device includes at least one processor 1712 and at least one physical memory 1714. Processor 1712 may be, for example, a central processing unit, a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, or combinations thereof. Memory 1714 may include a volatile or non-volatile memory (e.g., a flash memory, a random access memory (RAM), and/or a read-only memory (ROM)). The memory 1706 may store instructions for execution by the processor 1712.

User device 1702 may also include at least one network interface 1716 for wired and/or wireless communications with an external system and/or network (e.g., an intranet, the Internet, a P2P network, a WAN and/or a LAN). A network interface may enable user device 1702 to carry out communications (e.g., wireless communications) with systems external to user device 1702, such as system 500, system 800 and/or system 900, over network 1704. The structure of the network interface 1716 will depend on how the user device 1702 interfaces with the network. For example, if the user device 1702 is a smartphone or tablet, the network interface 1716 may comprise a transmitter/receiver with an antenna to send and receive wireless transmissions over the network 1704. If the user device 1702 is a personal computer connected to the network 1704 with a network cable, the network interface 1716 may comprise a network interface card (NIC), and/or a computer port (e.g. a physical outlet to which a plug or cable connects), and/or a network socket, etc.

User device 1702 may optionally include at least one input/output (I/O) interface 1718, alternatively referred to as user interface 1718, which may interface with optional input device(s) (not shown) and/or optional output device(s) (not shown). Input device(s) may include, for example, buttons, a microphone, a touchscreen, a keyboard, etc. Output device(s) may include, for example, a display, a speaker, etc. In this example, optional input device(s) and optional output device(s) may be external to user device 1702. In other examples, one or more of the input device(s) and/or output device(s) may be an internal component of user device 1702.

It will be appreciated that computing system 1700 may be used by a user of user device 1702 to perform any method 1000, method 1100, method 1200, method 1300, method 1400, method 1500 and/or method 1700. Computing system 1700 may also be used by a user of user device 1702 to perform variations of these methods or other methods using system 500, system 800 and/or system 900.

For example, user device 1702 may transmit input 512, including input prompt 512a and image 512b, to system 500 (or system 800 and/or system 900). System 500 may classify or categorize input 512 using any of the methods describe above.

In some implementations, input 512 may be rescaled and/or compressed, such as to reduce the memory and computing resources required to transmit input 512 over network 1704 and/or process input 512 using processor 1712 or one or more processors within system 500. For example, if the input includes image 512b, the rescaling may reduce the resolution of image 512b. Image 512b may also be converted from color to grayscale. In some other implementations, processor 1712 and one or more processors within system 500 may perform rescaling together, e.g. processor 1712 may partially rescale image 512b and one or more processors within system 500 may complete the rescaling of image 512b.

It will be appreciated that user device 1702 may also transmit other types of input to system 500 (or system 800 and/or system 900), such as input including different types of data and/or multiple types of data.

Technical benefits of some implementations herein are as follows. A classifier is implemented using a generative language model. In some implementations, this generative language model is an LLM. The generative language model is advantageously modified in the manner explained herein to be able to generate output that is always grammar compliant, e.g. by applying the mask in the manner explained herein.

Generally, a grammar-constrained generative language model represents an improvement in the functionality of the generative language model and hence the computing system implementing the generative language model because it may mitigate the technical problem of hallucination. For example, the generative language model may be modified to incorporate application of a mask (e.g. like in the examples shown in FIGS. 8-9), such that the generative language model can only select a next token that is valid, i.e. a next token that when appended to the already-generated token sequence maintains the grammar-compliance of the sequence. The generative language model is thereby modified and improved to limit its output to only a sequence of grammar-compliant tokens, that is, a valid sequence defined by the grammar. This can also result in a more efficient implementation compared to not modifying the generative language model to apply the mask, but instead checking for grammar compliance of a next token after that next token is output from the generative language model. In an implementation in which the next token is generated by the generative language model without regard to the grammar, and then a separate step is performed to check for grammar compliance, there will be inefficiencies if that next token is not grammar compliant. It will be necessary to have the generative language model generate a new token, then check that new token, and if it is also not grammar-compliant then repeat the process again in an iterative manner until a token is output from the generative language model that is determined to be grammar-compliant. Not only does this result in multiple iterations, but for those multiple iterations to be implemented the generative language model would need to store the probabilities of each token being a next token until the iterative process is complete, that is, until the generative language model finally outputs a token that is grammar compliant. By instead modifying the generative language model in the way described herein, e.g. by applying the mask, the generative language model always and only outputs a next token that is grammar-compliant. The multiple iterations just described would not need to be performed, which results in fewer computing resources and faster speed.

In a different implementation, the most probable tokens output from the generative language model (e.g. output from the softmax function) may be compared to the grammar, and a grammar-compliant token selected as the next token, e.g. the next token may be the most probable next token that is also grammar-compliant. However, this suffers from the same multiple-iteration problem discussed above. For example, if the top one hundred most probable tokens are output by the generative language model, and if there are no grammar-compliant tokens in that set of one hundred tokens, then the generative language model needs to output the next top one hundred most probable tokens, and this continues until a grammar compliant token is found. While this is happening, the generative language model needs to halt operation and retain in memory the probability value for every token so that it can output different subsets of tokens (e.g. each subset of a size of one hundred tokens) over the multiple iterations. Moreover, in a scenario that there is a grammar-compliant token in the subset of the top one hundred most probable tokens, then another grammar-compliant token that is not in the subset of top one hundred most probable tokens can never be chosen as the next token, which is a form of undesirable skewing. In contrast, in some implementations herein, the generative language model is modified to perform masking so that it will only output a token that is grammar-compliant, and all grammar-compliant next tokens have a chance of being selected. This avoids the multiple iterations described above (thereby reducing computations) and also avoids the undesirable skewing issue described above.

In some implementations herein, the application of the mask may be efficiently applied/implemented, e.g. through a tensor product or vector product, like in the examples of FIGS. 8 and 9. The generative language model may already be optimized (e.g. by use of a GPU) to perform specialized operations/computations like tensor products in order to execute other operations of the generative language model. Therefore, implementing the mask also as a tensor product (like in the example of FIG. 8) or similar (e.g. the vector product of the example of FIG. 9) uses the same type of operation the generative language model is already optimized to perform, thereby reducing/optimizing computer operations required to perform the mask operation. The result is a more computationally efficient implementation, e.g. compared to an alternative implementation in which the generative language model is not modified, but instead the check for grammar compliance is done as a separate step after the token is generated.

In addition, the classifier described herein (e.g. depicted in FIGS. 4-12), which includes a grammar-constrained generative language model, also provides several technical advantages over typical classifiers. Typical classifiers may be implemented using, for example, neural networks, K-nearest neighbours and support vector machines, and generally must be trained on a large data set representative of the taxonomy within which the classifier will classify/categorize input. In particular, typical classifiers must be trained on a large input sample/dataset to accurately classify inputs. For example, if a classifier is trained to classify elements in an image with 128 pixels, a large sample size may be required for the classifier to accurately classify based on this limited information. This poses scaling challenges and may also consume significant computational and networking resources. However, the classifier described herein, which includes a grammar-constrained generative language model, may be originally trained on a large but generic dataset, rather than a large dataset representative of the taxonomy for classification. Instead, the taxonomy may be represented in the grammar, which is used to constrain the output of the generative language. As a result, the generative language model may be used to classify within the taxonomy without actually been trained on a large dataset representative of the taxonomy. This leads to several technical improvements over typical classifiers.

For example, if an input may be classified within one or more possible taxonomies, a typical classifier may be required for each of those taxonomies, i.e. each typical classifier must be trained on a large dataset representative of that taxonomy for accurate classification. However, if the classifier is implemented using the classifier described herein, which implements a grammar-constrained generative language model, only one instance of the classifier may be required. Each taxonomy may be represented by an appropriate grammar (or, in some implementations, one grammar may contain all the taxonomies, as depicted in FIG. 19), and the output of the classifier may just be constrained by the grammar to accurately classify the input within the desired taxonomy. As such, the classifier described herein reduces memory consumption, since only one trained classifier plus grammars may be required in memory as opposed to multiple classifiers for each taxonomy. The classifier described herein also reduces computational and networking resources because only a single generative language model may need to be trained on a generic data set, as opposed to training a new classifier for each possible taxonomy that may need to be classified. It will be appreciated that the classifier described herein also addresses scaling challenges.

In addition, if a new classification category needs to be added to a taxonomy after a typical classifier has already been trained to classify within the taxonomy, the typical classifier must be recreated and retrained to classify within the updated taxonomy. It will be appreciated that unlike typical classifiers, the classifier described herein (e.g. depicted in FIGS. 4-12) may be reconfigured to classify an updated taxonomy possibly without retraining or fine-tuning. This may also result in a reduction in the consumption of computing resources, as well as an improvement in computing speed and efficiency. For example, if a new category is added to the classifier taxonomy, only the grammar needs to be updated (see, e.g., method 1600 depicted in FIG. 18). Once that is complete, the classifier may be able to classify inputs within the updated taxonomy.

It will also be appreciated that in applications involving generative language models (e.g. LLMs) but where a classifier is needed, it may be advantageous to use only a generative language model rather than a generative language model and a separate classifier. This may also simplify the computing architecture, as well as reduce networking constraints and the computing resources needed for training and storing a separate classifier (or multiple separate classifiers). The same generative language model, such as an LLM, may be used for multiple purposes, without the need for a different type of machine learning model or even a different model in general. The generative language model may be re-configured for a different purpose, such as classification, by constraining its output using a grammar. The generative language model may then be used for a more general purpose without the use of the grammar, or its purpose may be re-configured by using a different grammar to constrain its output.

It will also be appreciated that typical classifiers may be provided with an input, such as an image with 128 pixels, and be asked to classify that input. However, the classifier described herein, which is implemented using a generative language model, may be provided with additional context that may be useful for classification. For example, the generative language model may be provided with a description of the desired taxonomy and its categories. In the case of an input image depicting a ball, where the classifier is asked to classify the image within a sport, the generative language model may be provided with context that the image was taken from a basketball court (as opposed to a soccer field, etc.). The classifier disclosed herein thus results in a technical improvement over typical classifiers, since it allows for context-dependent classification, which may be used to improve the accuracy of the classification.

As discussed above, one problem of generative language models compared to conventional/typical machine learning classifiers is that they have a tendency to “hallucinate,” such that they provide an output that is incorrect or not relevant to the input into the generative language model, such as an LLM. Hallucination is a technical problem that can occur because of factors such as incomplete training or fine-tuning of the LLM. In one example, hallucinations result when, during training of the generative language model, an encoder of the LLM learns wrong correlations between different parts of the training data. One example of hallucination is as follows. An LLM provided with a prompt, including text and an image depicting a shoe, may provide an output indicating that the image depicts a stiletto or high-heels, rather than a shoe or one of the other predefined categories. It may also output text completely unrelated to the prompt.

One possible solution to the problem of hallucination may involve modifying the textual description after it has been generated by the generative language model (e.g. LLM). For example, an input image for classification may depict a shoe kicking a ball. The LLM may generate the output “the image depicts a soccer shoe, which is an article of clothing”. The solution may involve by replacing “soccer shoe” with “shoe”, and making similar corrections to other non-standard terms and formatting in the textual description. However, this solution is limited because even if the plurality of categories in the taxonomy are provided in the textual description (e.g. the input prompt) to the LLM, the LLM may not actually adhere to the instruction. This can occur when the textual description or input prompt is particularly large. The more informationally dense the data input to the LLM, the less likely the LLM is to pay attention to specific portions of the textual description containing instructions. In addition, this solution is also limited because the LLM might not output a textual description that is easily modified, e.g. it may output words that have not been contemplated in advance as alternatives to words in the desired terminology. Moreover, it will be appreciated that LLMs generate textual output comprising a sequence of tokens. Each token in the sequence may be generated based on a probability associated with that token which is based on the previous tokens in the sequence. Consequently, replacing terms in the textual output of the LLM, wherein each term may include or be based on one or more tokens, may not adequately correct for errors in the textual output. In particular, those tokens occurring after modified tokens in the textual output could have been different had the modified tokens appeared in the original sequence. Those modified tokens would have been considered by the LLM while generating subsequent tokens within the sequence. For example, the LLM may not have generated the sequence of tokens “article of clothing” had the term “soccer shoe” not appeared in the sequence. Instead, the LLM may have generated the output “sport”: “football” had the term “sport” appeared at the start of the original sequence generated by the LLM. Moreover, after the sequence of tokens is generated, it is no longer known what the second most probable output from the LLM was instead of “soccer shoe” (but not selected by the LLM), and so the second most probable output cannot be relied upon to determine an alternative word within the desired terminology. It will be understood that information which may have appeared in the sequence of tokens may thus be lost.

To address the technical problems of hallucination described above, a generative language model may be modified so that it can only generate an output that classifies the input into one of the predefined categories of the taxonomy. The output may also conform to a predefined format as well. This may be implemented by employing a grammar. The grammar may define valid sequences of output (e.g. valid sequences of symbols) corresponding to a plurality of categories (and/or format). The input can be classified into one or more of the plurality of categories. For example, the grammar may include symbols, such as text, identifying or delineating the plurality of categories. The plurality of categories may be the classifier taxonomy, e.g. the predefined categories of the classification. Following the example provided immediately above, the grammar may include (or define) the taxonomy of sports, namely “hockey”, “basketball” and “football” (rather than soccer). The grammar-constrained LLM/generative language model (depicted, for example, in FIGS. 3-9) may thus address the technical problem of hallucination in generative language models and also provide an accurate classifier with the various computational, networking and architectural improvements discussed above.

Finally, there are also several additional technical benefits specifically in relation to an implementation in which there are multiple processing units, e.g. where there are separate first and second processing units like in FIG. 10. The generative language model can be implemented on a first processing unit that is specialized for executing the operations of a machine learning model, e.g. performing the tensor products in the neural network. For example, the first processing unit may be a GPU. The first processing unit may be primarily or solely dedicated to just implementing the generative language model, e.g. through a parallel structure dedicated to accelerating computer operations, and may efficiently perform operations such as tensor products. The first processing unit may be configured to apply the mask as part of implementing the generative language model, e.g. as an additional or final layer. The application of the mask may be implemented in the same way as other product operations (e.g. as a tensor or vector product), which the first processing unit is already specialized to perform. This may result in computationally efficient application of the mask. The second processing unit may communicate with the first processing unit over a network or bus. The second processing unit need not be specialized to execute the generative language model, but may be a more general purpose processor such as a CPU. The second processing unit may perform a variety of supporting operations that leverage the generative language model. For example, the second processing unit may provide a user interface to the user, receive the prompt from the user, process the output from the generative language model, etc. The second processing unit may store the grammar and generate the mask so that this need not be done by the generative language model, thereby advantageously allowing for the first processing unit to implement a generative language model that is not specific to a grammar even though it produces a grammar-compliant output. The first processing unit need only return the next token to the second processing unit (like in FIG. 10), rather than probability values (e.g. log it values) generated in the generative language model.

In a different implementation in which the most probable tokens output from the generative language model (e.g. the top 100 most probable tokens) are output and compared to the grammar, it would be necessary to send the tokens and/or the plurality of probability values corresponding to those tokens over the network or bus from the first processing unit (e.g. GPU) to the second processing unit (e.g. CPU). This would need to occur for every iteration. Moreover, the comparison of those tokens to the grammar to determine whether each one is grammar-compliant would need to occur on the second processing unit, which in general is slower because the second processor is not specialized. For example, assuming the second processing unit is a CPU, it would take many CPU cycles to validate the top one hundred most probable next tokens for every token generation step, and if a valid (grammar-compliant) token is not in the top one hundred most probable next tokens it would be required to obtain a different and/or larger set of tokens to check. This suffers from the problem of the multiple iterations (as well as other problems), and also the transfer of multiple values from the first processing unit to the second processing unit. Alternatively, in the implementation described in relation to FIG. 10, it is not necessary to transmit all of a tensor and/or multiple tokens between the first processing unit (e.g. GPU) and the second processing unit (e.g. CPU). Instead, only the next token generated by the generative language model needs to be transmitted from the first processing unit to the second processing unit (as shown at step 838 of FIG. 10) because that next token is always grammar compliant. That is, instead of sending some or all of a tensor and/or tokens between the first and second processing units, a mask 722 is constructed on the second processing unit using the token sequence 806 and grammar 616, and that mask 777 is then sent to the first processing unit (at step 834), and then the mask 722 is applied in the generative language model to ensure that a next token 708 is generated that is always grammar-compliant. Then only that grammar-compliant next token 708 needs to be sent from the first processing unit to the second processing unit (at step 838). This results in an implementation that requires fewer transmissions between processing units and that is more computationally efficient than having to perform the multiple iterations described above in the alternative implementation.

### CONCLUSION

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

The scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Any module, component, or device exemplified herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor readable storage media.

Memory, as used herein, may refer to memory that is persistent (e.g. read-only-memory (ROM) or a disk), or memory that is volatile (e.g. random access memory (RAM)). The memory may be distributed, e.g. a same memory may be distributed over one or more servers or locations.

1. A computer-implemented method comprising:
receiving a prompt that instructs a generative language model to classify an input to the generative language model;
obtaining a grammar responsive to the prompt, the grammar defining valid sequences of symbols corresponding to a plurality of categories, wherein the input can be classified into one or more of the plurality of categories; and
generating, using the generative language model, a sequence of symbols identifying the one or more categories, the sequence based on the input and conforming to the grammar.

2. The computer-implemented method of claim 1, further comprising outputting an indication of the one or more categories into which the input has been classified based on the sequence of symbols.

3. The computer-implemented method of claim 1, wherein the symbols comprise tokens, and wherein generating the sequence of symbols includes:
generating a plurality of values using the generative language model, each of the values indicative of a probability of a respective token being a next token of the sequence;
applying a mask to the plurality of values, the mask operating on each value that corresponds to a token not compliant with the grammar to reduce or zero the probability of the token being the next token; and
determining the next token based on the plurality of values after the mask is applied.

4. The computer-implemented method of claim 1, wherein the sequence of symbols, when mapped to text, provides a written indication of the one or more categories.

5. The computer-implemented method of claim 1, wherein the prompt further comprises an instruction, and wherein obtaining the grammar responsive to the prompt further comprises obtaining the grammar based on the instruction.

6. The computer-implemented method of claim 5,
wherein the instruction comprises information associated with the plurality of categories; and
wherein obtaining the grammar based on the instruction further comprises:
encoding the information associated with the plurality of categories within the grammar,
wherein the encoding is in a format for parsing.

7. The computer-implemented method of claim 5,
wherein the grammar further comprises a label representative of the plurality of categories to which the grammar relates; and
wherein obtaining the grammar based on the instruction further comprises:
determining that the instruction is associated with the label; and
selecting the grammar from a set of one or more grammars.

8. The computer-implemented method of claim 5,
wherein a memory comprises information associated with the plurality of categories; and
wherein obtaining the grammar based on the instruction further comprises:
retrieving the information associated with the plurality of categories from the memory; and
encoding the information associated with the plurality of categories within the grammar,
wherein the encoding is in a format for parsing.

9. The computer-implemented method of claim 1, further comprising:
receiving an update to the plurality of categories, the update including at least one of an addition of a new category to the plurality of categories, a removal of a category from the plurality categories, or a modification of a category within the plurality of categories; and
modifying the valid sequences of symbols in the grammar based on the update to the plurality of categories.

10. The computer-implemented method of claim 1, wherein the generative language model is a large language model (LLM).

11. The computer-implemented method of claim 2, wherein the grammar further constrains the valid sequences of symbols to a syntax of a programming language; and wherein outputting an indication of the one or more categories into which the input has been classified based on the sequence of symbols comprises outputting code of the programming language.

12. A system comprising:
a memory to store a grammar; and
at least one processor to:
receive a prompt that instructs a generative language model to classify an input to the generative language model;
obtain the grammar responsive to the prompt, the grammar defining valid sequences of symbols corresponding to a plurality of categories, wherein the input can be classified into one or more of the plurality of categories; and
generate, using the generative language model, a sequence of symbols identifying the one or more categories, the sequence based on the input and conforming to the grammar.

13. The system of claim 12, wherein the at least one processor is to output an indication of the one or more categories into which the input has been classified based on the sequence of symbols.

14. The system of claim 12, wherein the symbols comprise tokens, and wherein generating the sequence of symbols includes:
generating a plurality of values using the generative language model, each of the values indicative of a probability of a respective token being a next token of the sequence;
applying a mask to the plurality of values, the mask operating on each value that corresponds to a token not compliant with the grammar to reduce or zero the probability of the token being the next token; and
determining the next token based on the plurality of values after the mask is applied.

15. The system of claim 12, wherein the prompt further comprises an instruction, and wherein obtaining the grammar responsive to the prompt further comprises obtaining the grammar based on the instruction.

16. The system of claim 15,
wherein the instruction comprises information associated with the plurality of categories; and
wherein obtaining the grammar based on the instruction further comprises:
encoding the information associated with the plurality of categories within the grammar,
wherein the encoding is in a format for parsing.

17. The system of claim 15,
wherein the grammar further comprises a label representative of the plurality of categories to which the grammar relates; and
wherein obtaining the grammar based on the instruction further comprises:
determining that the instruction is associated with the label; and
selecting the grammar from a set of one or more grammars.

18. The system of claim 15,
wherein obtaining the grammar based on the instruction further comprises:
retrieving information associated with the plurality of categories; and
encoding the information associated with the plurality of categories within the grammar,
wherein the encoding is in a format for parsing.

19. The system of claim 12, wherein the generative language model is a large language model (LLM).

20. One or more non-transitory computer readable media having stored thereon computer-executable instructions that, when executed by at least one computer, cause the at least one computer to perform a method comprising:
receiving a prompt that instructs a generative language model to classify an input to the generative language model;
obtaining a grammar responsive to the prompt, the grammar defining valid sequences of symbols corresponding to a plurality of categories, wherein the input can be classified into one or more of the plurality of categories; and
generating, using the generative language model, a sequence of symbols identifying the one or more categories, the sequence based on the input and conforming to the grammar.
